(19) United States
(12) Patent Application Publication
(10) Pub. No.: US 2026/0239276 A1
(43) Pub. Date: Aug. 13, 2026

(54) METHODS AND TOOLS TO ENABLE MULTI-RTT BASED ON SINGLE SATELLITE IN NTN

(71) Applicant: Telefonaktiebolaget LM Ericsson (publ), Stockholm (SE)

(72) Inventors: Deep Shrestha, Linköping (SE); Min Wang, Luleå (SE); Ming Li, Stockholm (SE); Ritesh Shreevastav, Upplands Väsby (SE)

(21) Appl. No.: 19/155,340

(22) PCT Filed: Feb. 16, 2024
(86) PCT No.: PCT/IB2024/051516

§ 371 Date: Aug. 11, 2025

Related U.S. Application Data
(60) Provisional application No. 63/485,460, filed on Feb. 16, 2023.

(51) Int. Cl. H04W 64/00; G01S 13/76; G01S 19/25; H04L 5/00; H04W 84/06

(52) U.S. Cl. CPC H04W 64/00; G01S 13/765; G01S 19/258; H04L 5/0048; H04W 84/06

(57) ABSTRACT

Various embodiments described herein provide for methods that allow a location server, e.g., a Location Management Function (LMF) to facilitate determining the location of a User Equipment (UE) using multi Round Trip Time (RTT) measurements by a single satellite in a Non-Terrestrial Network (NTN) by using the orbital movement of the satellite to perform successive positioning measurements to the UE. The UE and the satellite can send their respective positioning measurements to the LMF, along with time stamps at which the positioning measurements were obtained, and the LMF, using the known location and timing of the satellite, can determine the location of the UE. The LMF can also consider the UE processing capability to configure the UE with uplink (UL) transmission time stamps indicating the start of transmission of UL reference signals for positioning measurements.

### RELATED APPLICATIONS

This application claims the benefit of provisional patent application Ser. No. 63/485,460, filed Feb. 16, 2023, the disclosure of which is hereby incorporated herein by reference in its entirety.

### TECHNICAL FIELD

The present disclosure relates to methods for performing multi-Round Trip Time (RTT) positioning using a single satellite node in a Non-Terrestrial Network (NTN).

### BACKGROUND

A Non-Terrestrial Network (NTN) typically includes the following elements:
One or several satellite gateways that connect the NTN to a public data network
   A Geostationary Orbit (GEO) satellite is fed by one or several satellite gateways which are deployed across the satellite targeted coverage (e.g. regional or even continental coverage). It is assumed that User Equipments (UEs) in a cell are served by only one satellite gateway.
   A Non-GEO satellite is served successively by one or several satellite gateways at a time. The system ensures service and feeder link continuity between the successive serving satellite gateways with sufficient time duration to proceed with mobility anchoring and hand-over.
A Feeder link or radio link between a satellite gateway and the satellite (or Unmanned Aircraft Systems (UAS) platform)
A service link or radio link between the UE and the satellite (or UAS platform)
A satellite (or UAS platform) which may implement either a transparent or a regenerative (with on board processing) payload. The satellite (or UAS platform) typically generates several beams over a given service area bounded by its field of view. The footprints of the beams are typically of elliptic shape. The field of view of a satellite (or UAS platforms) depends on the on-board antenna diagram and minimum elevation angle.
   Transparent Payload: Radio Frequency (RF) filtering, frequency conversion, and amplification. Hence, the waveform signal repeated by the payload is un-changed.
   Regenerative Payload: RF filtering, frequency conversion, and amplification as well as demodulation/decoding, switching and/or routing, and coding/modulation. This is effectively equivalent to having all or part of base station functions (e.g. New Radio (NR) gNodeB (gNB)) on-board the satellite (or UAS platform).
Inter-Satellite Links (ISLs) optionally in case of a constellation of satellites. This will require regenerative payloads on-board the satellites. ISL may operate in RF frequency or optical bands.
UE are served by the satellite (or UAS platform) within the targeted service area.

There may be different types of satellites (or UAS platforms), such as e.g., those shown in Table 1 below.

TABLE 1
Types of Satellites and UAS Platforms

| | | | | Typical beam | |
|---|---|---|---|---|---|
| Platforms | Altitude range | | Orbit | footprint size | |
| Low-Earth Orbit | 300-1500 | km | Circular around the earth | 100-1000 | km |
| (LEO) satellite | | | | | |
| Medium-Earth | 7000-25000 | km | | 100-1000 | km |
| Orbit (MEO) | | | | | |
| satellite | | | | | |
| Geostationary | 35 786 | km | notional station keeping | 200-3500 | km |
| Earth Orbit (GEO) | | | position fixed in terms of | | |
| satellite | | | elevation/azimuth with | | |
| UAS platform | 8-50 km (20 | | respect to a given earth | 5-200 | km |
| (including HAPS) | km for HAPS) | | point | | |
| High Elliptical | 400-50000 | km | Elliptical around the earth | 200-3500 | km |

Orbit (HEO)
satellite

Example architectures with NTNs are shown in FIGS. 1, 2, 3, and 4. In particular, FIG. 1 illustrates a networking-Radio Access Network (RAN) architecture with a transparent satellite. FIG. 2 illustrates an architecture including a regenerative satellite without ISL where the gNB processes the payload. FIG. 3 illustrates an architecture including a regenerative satellite with ISL where the gNB processes the payload. FIG. 4 illustrates a Next Generation RAN (NG-RAN) with a regenerative satellite based on gNB-Distributed Unit (DU).

In addition to the scenarios illustrated in FIGS. 1, 2, 3, and 4, multi-connectivity scenarios are also being discussed in the 3^{rd} Generation Partnership Project (3GPP), where either transparent or regenerative NTN-based NG-RAN is combined with terrestrial-based NG-RAN (NR or Evolved Universal Terrestrial Radio Access (EUTRA)) or another NTN. Hence, a UE may be connected and served simultaneously by at least:
One NTN-based NG-RAN and one terrestrial-based access (NR or EUTRA), or
One NTN-based NG-RAN and another NTN-based NG-RAN.

NTN can have beam-based coverage, e.g., as in FIG. 5, which illustrates a typical NTN scenario based on regenerative payload with beam-based coverage.

Positioning has been a topic in Long Term Evolution (LTE) standardization since 3GPP Release 9. The primary objective of positioning in LTE was to fulfill regulatory requirements for emergency call localization where the target was to achieve less than 50 meters (m) horizontal accuracy.

Starting from 3GPP Release 15 specification, positioning is also supported in NR. Positioning in NR is supported by the architecture shown in FIG. 6. The interactions between the gNB and the UE is supported via the Radio Resource Control (RRC) protocol, while the location node interfaces with the UE via the LTE positioning protocol (LPP). LPP is a common protocol to both NR and LTE. The Location Management Function (LMF) is the location node in NR. There are also interactions between the location node and the gNB via the NR positioning protocol (NRPPa).

As described in clause 5.2 of 3GPP Technical Specification (TS) 38.305 V 17.1.0, the overall sequence of events applicable to the UE, NG-RAN, and LMF for any location service is shown in FIG. 7.

Note that when the Access and Mobility Management Function (AMF) receives a Location Service Request in case of the UE is in connected mode idle (CM-IDLE) state, the AMF performs a network triggered service request in order to establish a signaling connection with the UE and assign a specific serving gNB or next generation eNodeB (ng-eNB). The UE is assumed to be in connected mode before the beginning of the flow shown in FIG. 7; that is, any signaling that might be required to bring the UE to connected mode prior to step 1a is not shown. The signaling connection may, however, be later released (e.g., by the NG-RAN node as a result of signaling and data inactivity) while positioning is still ongoing.

The steps of the procedure of FIG. 7 are as follows:
Step 1a. Either: some entity in the 5^{th} Generation Core (5GC) (e.g., Gateway Mobile Location Center (GMLC)) requests some location service (e.g. positioning) for a target UE to the serving AMF.
Step 1b. Or: the serving AMF for a target UE determines the need for some location service (e.g. to locate the UE for an emergency call).
Step 1c. Or: the UE requests some location service (e.g. positioning or delivery of assistance data) to the serving AMF at the Non-Access Stratum (NAS) level.
Step 2. The AMF transfers the location service request to an LMF.
Step 3a. The LMF instigates location procedures with the serving and possibly neighbouring ng-eNB or gNB in the NG-RAN—e.g., to obtain positioning measurements or assistance data.
Step 3b. In addition to step 3a or instead of step 3a, the LMF instigates location procedures with the UE—e.g. to obtain a location estimate or positioning measurements or to transfer location assistance data to the UE.
Step 4. The LMF provides a location service response to the AMF and includes any needed results—e.g. success or failure indication and, if requested and obtained, a location estimate for the UE.
Step 5a. If step 1a was performed, the AMF returns a location service response to the 5GC entity in step 1a and includes any needed results—e.g., a location estimate for the UE.
Step 5b. If step 1b occurred, the AMF uses the location service response received in step 4 to assist the service that triggered this in step 1b (e.g. may provide a location estimate associated with an emergency call to a GMLC).
Step 5c. If step 1c was performed, the AMF returns a location service response to the UE and includes any needed results—e.g. a location estimate for the UE.

Location procedures applicable to NG-RAN occur in steps 3a and 3b in FIG. 7 and are defined in greater detail in 3GPP TS 38.305. Other steps in FIG. 7 are applicable only to the 5GC.

Steps 3a and 3b can involve the use of different position methods to obtain location related measurements for a target UE and, from these measurements, compute a location estimate and possibly additional information like velocity.

Some of the Positioning Methods Supported by LTE include:

Enhanced Cell ID: Essentially cell identity (ID) information to associate the device to the serving area of a serving cell, and then additional information to determine a finer granularity of UE position.

Assisted GNSS: Global Navigation Satellite System (GNSS) information retrieved by the device, supported by assistance information provided to the device from the Evolved Serving Mobile Location Center (E-SMLC).

Observed Time Difference of Arrival (OTDOA): UE performs positioning measurement (reference signal time difference (RSTD) measurements in this case) on downlink positioning reference signal (DL-PRS) transmitted by base stations (BSs) and reports them to the E-SMLC for position estimation.

Uplink TDOA (UTDOA): Similar to OTDOA but in uplink (UL) direction. Positioning measurements are done by the network node on UE transmitted reference signal for positioning measurement in UL. The measurements are reported to E-SMLC where the ultimate position estimation is performed.

### Positioning Methods Supported by NR

In comparison to LTE, NR positioning benefits from larger bandwidth and finer beamforming and can localize a UE with higher accuracy and supports the following positioning methods:

Downlink (DL) Time Difference of Arrival (TDOA): The DL TDOA positioning method makes use of the downlink reference signal time difference (DL RSTD) measurement done by UE on positioning reference signal (PRS) transmitted by multiple transmission and reception points (TRPs). This method is similar to OTDOA in LTE.

Multi-Round Trip Time (RTT): The Multi-RTT positioning method makes use of multiple RTT measurements for UE position estimation. For each RTT measurement, the UE Receive (Rx)-Transmit (Tx) and gNB Rx-Tx time difference measurements are used.

Uplink (UL) TDOA: The UL TDOA positioning method makes use of the UL TDOA (and optionally UL Sounding Reference Signal (SRS) Reference Signal Received Power (RSRP), or SRS-RSRP) at multiple TRPs of uplink signals transmitted from UE. The receive points (RPs) measure the UL TDOA (and optionally UL SRS-RSRP) of the received signals using assistance data received from the positioning server, and the resulting measurements are used along with other configuration information to estimate the location of the UE.

DL Angle of Departure (AoD): The DL AoD positioning method makes use of the measured DL Positioning Reference Signal (PRS) RSRP of downlink signals received from multiple TRPs, at the UE. The UE measures the DL PRS RSRP of the received signals using assistance data received from the positioning server, and the resulting measurements are used along with other configuration information to locate the UE.

UL-Angle of Arrival (AoA): The UL AoA positioning method makes use of the measured azimuth and zenith of arrival at multiple TRPs of uplink signals transmitted from the UE. The TRPs measure Azimuth (A)-AoA and Zenith (Z)-AoA of the received signals using assistance data received from the positioning server, and the resulting measurements are used along with other configuration information to estimate the location of the UE.

NR-Enhanced Cell ID (ECID): NR ECID positioning refers to techniques which use additional UE measurements and/or NR radio resource and other measurements to improve the UE location estimate.

The NR positioning modes can be categorized into:
UE-Assisted: The UE performs measurements with or without assistance from the network and sends these measurements to the E-SMLC where the position calculation may take place.
UE-Based: The UE performs measurements and calculates its own position with assistance from the network.
Standalone: The UE performs measurements and calculates its own position without network assistance.

### SUMMARY

Various embodiments described herein provide for methods that allow a location server, e.g., a Location Management Function (LMF) to facilitate determining the location of a User Equipment (UE) using multi Round Trip Time (RTT) measurements by a single satellite in a Non-Terrestrial Network (NTN) by using the orbital movement of the satellite to perform successive positioning measurements to the UE. The UE and the satellite can send their respective positioning measurements to the LMF, along with time stamps at which the positioning measurements were obtained, and the LMF, using the known location and timing of the satellite, can determine the location of the UE. The LMF can also consider the UE processing capability to configure the UE with uplink (UL) transmission time stamps indicating the start of transmission of UL reference signals for positioning measurements.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates an exemplary Non-Terrestrial Network (NTN) architecture with a transparent satellite according to one or more embodiments of the present disclosure;

FIG. 2 illustrates another exemplary NTN architecture with a regenerative satellite without Inter-Satellite Links (ISL) according to one or more embodiments of the present disclosure;

FIG. 3 illustrates another exemplary NTN architecture with a regenerative satellite with ISL according to one or more embodiments of the present disclosure;

FIG. 4 illustrates another exemplary NTN architecture with a regenerative satellite based on a gNB-Distributed Unit (DU) according to one or more embodiments of the present disclosure;

FIG. 5 illustrates an exemplary NTN scenario based on regenerative payload with beam-based coverage according to one or more embodiments of the present disclosure;

FIG. 6 illustrates an exemplary positioning architecture in New Radio (NR) according to one or more embodiments of the present disclosure;

FIG. 7 illustrates an exemplary message sequence chart for positioning in NR according to one or more embodiments of the present disclosure;

FIG. 8 illustrates an exemplary embodiment of Multi-Round Trip Time (RTT) positioning according to one or more embodiments of the present disclosure;

FIG. 9 illustrates another exemplary embodiment of Multi-RTT positioning according to one or more embodiments of the present disclosure;

FIG. 10 illustrates an example of User Equipment (UE) positioning in NTN with a single satellite node according to one or more embodiments of the present disclosure;

FIG. 11 illustrates an example of a timing sequence for measuring RTT according to one or more embodiments of the present disclosure;

FIG. 12 illustrates an example of repeated timing sequences from FIG. 11 according to one or more embodiments of the present disclosure;

FIG. 13 illustrates an exemplary message sequence chart for multi-RTT based positioning in an NTN using a single satellite node according to one or more embodiments of the present disclosure;

FIG. 14 is a flow chart that illustrates the operation of a Location Management Function (LMF) in accordance with one embodiment of the present disclosure;

FIG. 15 is a flow chart that illustrates the operation of a UE in accordance with one embodiment of the present disclosure;

FIG. 16 is a different embodiment of the message sequence chart from FIG. 13 with different assistance information in accordance with one embodiment of the present disclosure;

FIG. 17 is a different embodiment of the message sequence chart from FIG. 16 with different assistance information in accordance with one embodiment of the present disclosure;

FIG. 18 shows an example of a communication system in accordance with some embodiments;

FIG. 19 shows a UE in accordance with some embodiments;

FIG. 20 shows a network node in accordance with some embodiments;

FIG. 21 is a block diagram of a host in accordance with some embodiments;

FIG. 22 is a block diagram illustrating a virtualization environment in accordance with some embodiments; and

FIG. 23 shows a communication diagram of a host communicating via a network node with a UE in accordance with some embodiments.

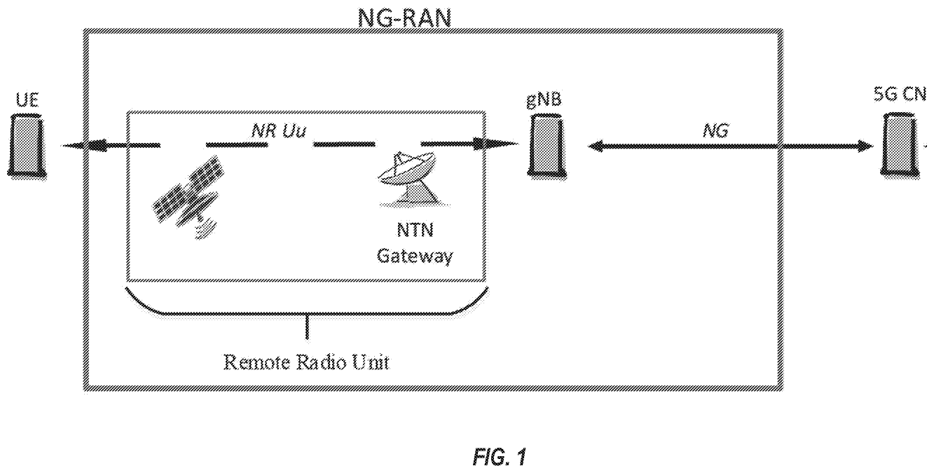

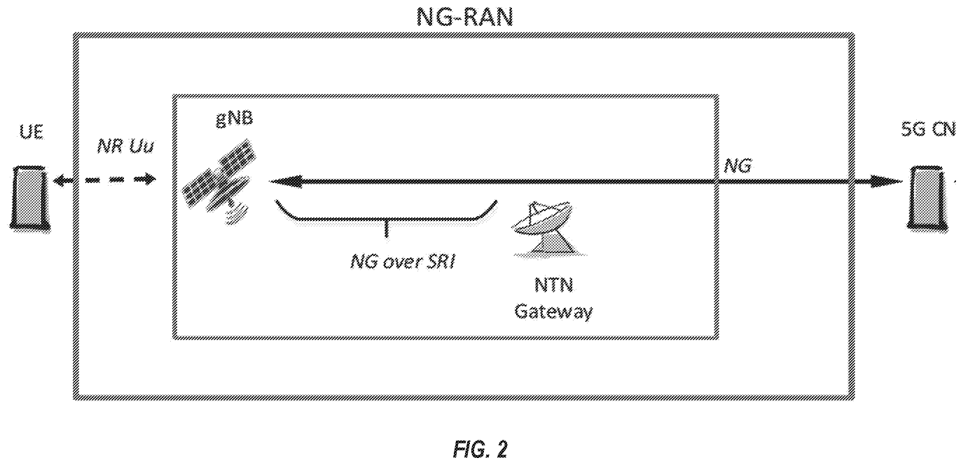

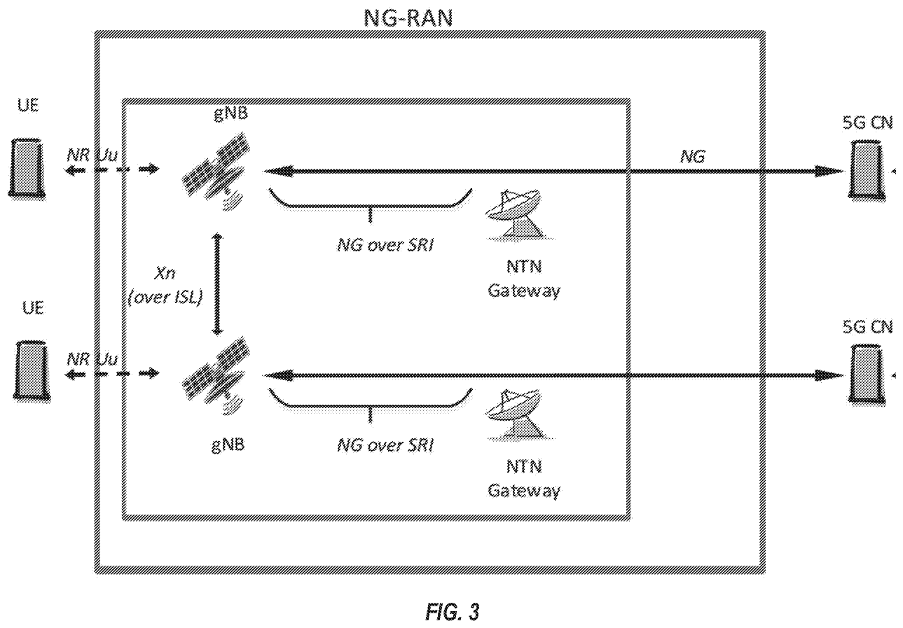

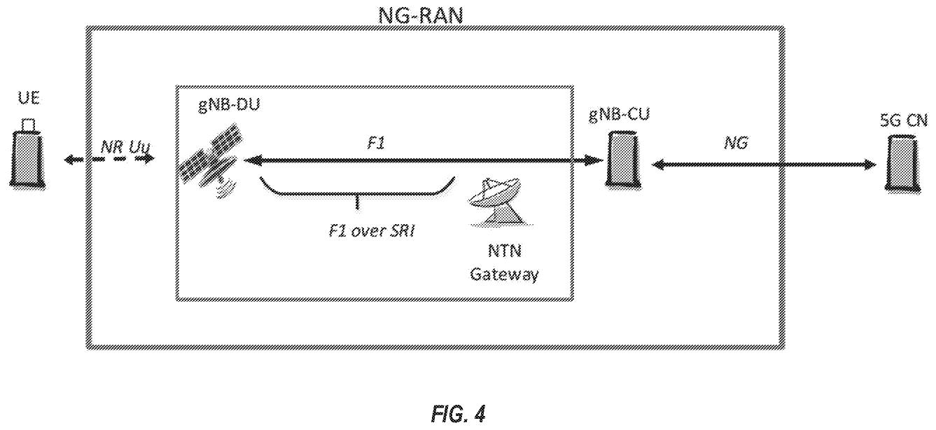

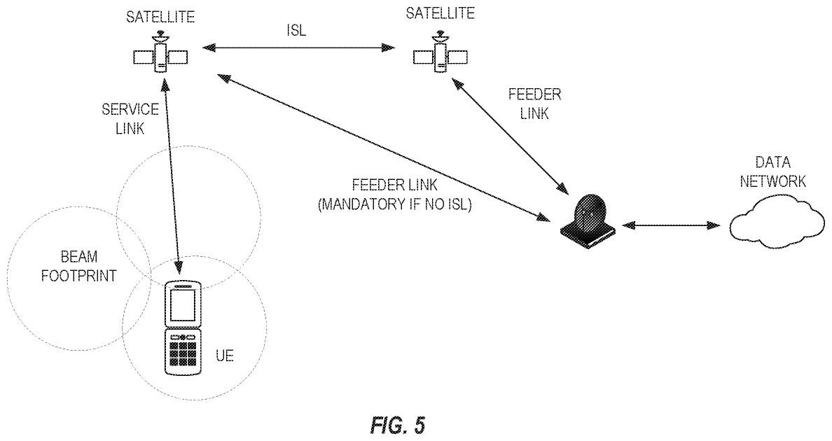

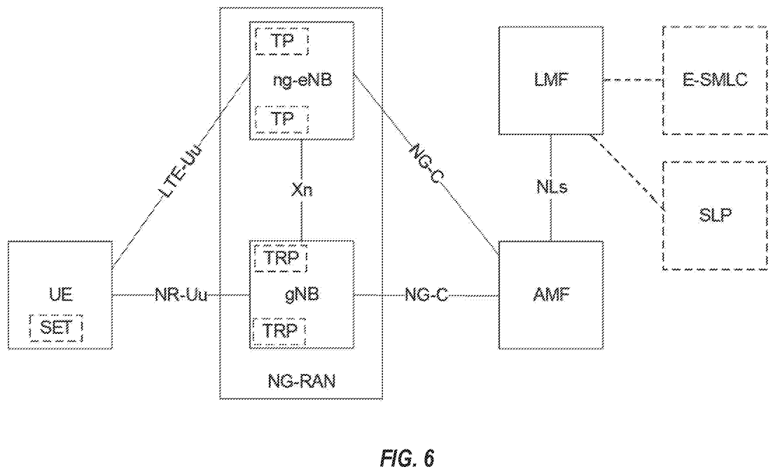

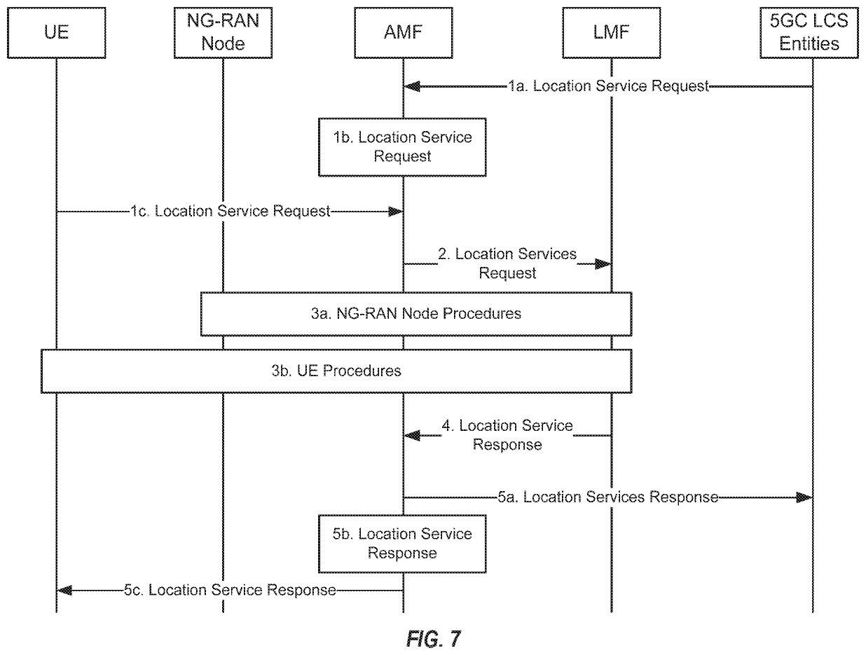

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

As used herein, a “terrestrial network node” may comprise a radio network node (e.g., base station (BS), New Radio (NR) gNodeB (gNB), gNB-Distributed Unit (DU), gNB-Central Unit (CU), relay or Integrated Access and Backhaul (IAB) node, radio network controller, Transmission and Reception Point (TRP), etc.) or a core network node (e.g., Access and Mobility Management Function (AMF), Session Management Function (SMF), User Plane Function (UPF), Mobile Switching Center (MSC), Mobility Management Entity (MME), Operations and Maintenance (O&M) node, Operations Support System (OSS) node, Self-Organizing Network (SON) node, positioning node, etc.).

As used herein, “Non-Terrestrial Networks (NTNs)” are networks, or segments of networks, using an airborne or space-borne vehicle to embark a transmission equipment relay node or base station.

Herein, the term “NTN node” is used to denote one or more radio network nodes or equipment at an airborne or space-borne vehicle, satellite (e.g., Low-Earth Orbiting (LEO) satellite, Medium Earth Orbiting (MEO) satellite, Geostationary Earth Orbiting (GEO) satellite, High Earth Orbiting (HEO) satellite, etc.), Unmanned Aerial Systems (UAS) platform, etc. capable of at least receiving radio signals from a User Equipment (UE) operating on the Earth. An NTN node's receivers may have specific Radio Frequency (RF) characteristics (e.g., sensitivity) and may operate in specific RF bands dedicated for NTN operation. An NTN node may also comprise a network node (e.g., gNB) of a special type, i.e., capable of NTN operation.

The terms location server, positioning node, Location Management Function (LMF), Evolved Serving Mobile Location Center (E-SMLC) can be used inter-changeably, at least in some examples.

The term “time resource” as used herein may correspond to any type of physical resource or radio resource expressed in terms of length of time. Examples of time resources are: symbol, time slot, subframe, radio frame, Transmit Time Interval (TTI), interleaving time, slot, sub-slot, mini-slot, etc.

There currently exist certain challenge(s). An NR NTN Work Item (WI) (i.e., NR NTN enhancements) has been defined for 3GPP Release 18 (as captured in RP-223534) where one of the objectives is to design solutions for network verified UE location in NTN networks as indicated below:
Based on RAN1 conclusions of the study phase, RAN to prioritize the specification of necessary enhancements to multi-RTT to support the network verified UE location in NTN assuming a single satellite in view [RAN1, 2, 3, 4].
DL-TDoA methods for verification may be considered as lower priority and if time permits and condition in Note is satisfied.

The existing NR positioning specification supports multiple Round Trip Time (multi-RTT) based positioning for cellular network where Transmission Reception Points (TRPs) are at fixed locations that are static and do not change over time. In contrast to this, the Release 18 Work Item Description (WID) objective is to design a multi-RTT solution for a network verified UE location. As mentioned in the list of objectives above, while designing the solution, it shall be assumed that there is only one satellite in view and the UE is expected to perform RTT measurement with the same satellite in different locations. Using multiple such measurements, UE position on Earth shall be estimated by the network. Therefore, to exploit multi-RTT for network verified UE position in NTN, an update to existing LPP protocol is needed. In contrast to the legacy solution where the LMF provides assistance data for positioning measurement to the UE based on static TRP location, for NTN, assistance data shall consider mobile TRP where multiple RTT measurements are done on the PRS transmitted by the same satellite from different locations at different time instants. In order to locate a target UE, multiple measurement instants are taken together to mimic different TRPs. At each measurement instant, both the UE and the satellite (gNB) need to provide Reception (RX)-Transmission (TX) difference reports.

Multi-RTT positioning is introduced to determine the RTT from measurements in downlink and uplink for positioning purpose. Since 3GPP Release 16, NR provides Downlink (DL) Positioning Reference Signal (PRS) and Uplink (UL) Sounding Reference Signal (SRS) UL-SRS signals. The DL-PRS signal is a permuted and staggered comb-Quadrature Phase Shift Keying (QPSK) signal carrying a Pseud-random Noise (PN) sequence, while the UL-SRS signal is a regular comb signal carrying a Zadoff-Chu sequence. Both types of signals can be correlated against at the respective end point with a corresponding replica signal. The time instance where the correlation peak occurs allows the delay between transmitter and receiver to be determined.

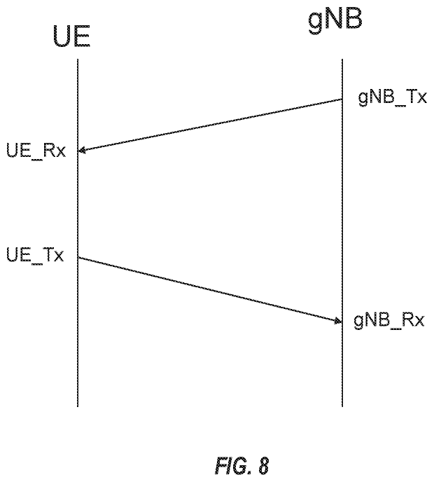

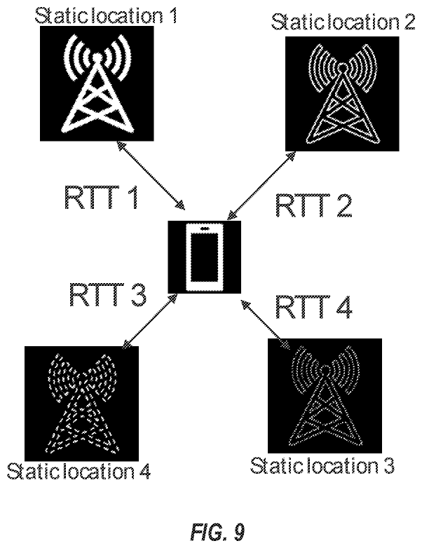

The Multi-RTT positioning method is illustrated in FIG. 8 and FIG. 9. In particular, FIG. 8 illustrates RTT calculation. FIG. 9 illustrates an example of cellular network deployment and UE positioning. Firstly, for each pair of gNB and UE, the RTT is calculated from (gNB_Rx−gNB_Tx)−(UE_Rx−UE_Tx). After RTTs of all pairs of gNB and UE are determined, the LMF is able to estimate the distance between UE and each gNB and in turn the UE position provided gNB position is known.

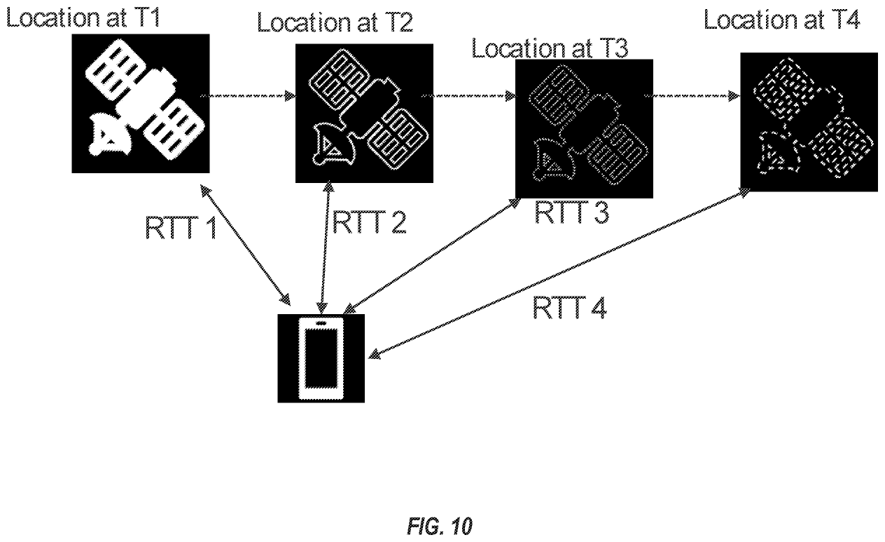

FIG. 10 illustrates an example of UE positioning in NTN where single satellite node is transmitting PRS resource(s). As illustrated in this example, four different RTTs (RTT1, RTT2, RTT3, and RTT4) are measured between the UE and a single TRP at four different times (T1, T2, T3, and T3), respectively. Using these measured RTTs along with the known positions of the single satellite node at T1, T2, T3, and T4, the UE position can be calculated.

For multi-RTT based UE location verification in NTN involving the LMF, the detailed procedure can be, firstly, the network should configure the positioning resources. Compared to legacy multi-RTT positioning, the network can also configure the period of RTT measurement. After triggering of measurement, the UE and network node periodically measure the DL-PRS and transmit UL-SRS resource(s) according to the configured positioning resources. Then, the network node and/or UE may report the Rx-Tx time difference every time after measurement or in one shot after all the measurements. After the measurements, the LMF determines the RTTs and calculates UE position.

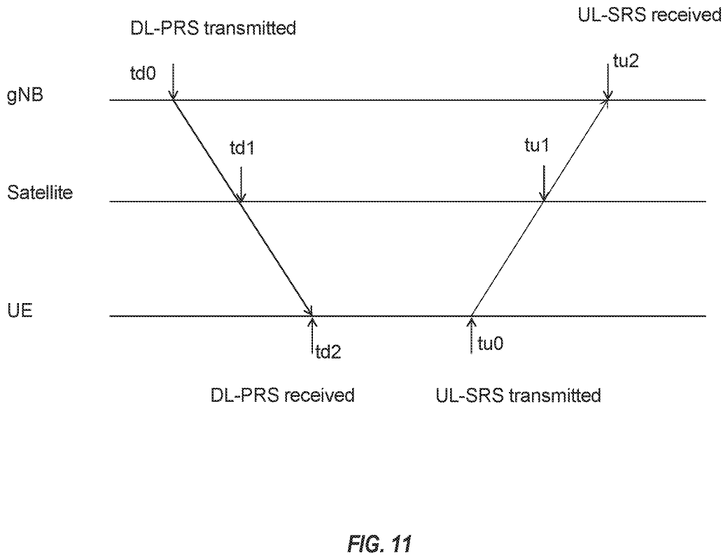

A timing sequence for measuring RTT is shown in FIG. 11. In each RTT measurement, after LMF operations, in downlink, the gNB transmits PRS at td0, the satellite receives and transmits PRS to UE at td1, and the UE receives and starts to measure PRS at td2. In the same manner, the UE transmits SRS at tu0, the satellite node receives and transmits SRS to the gNB at tu1, and the gNB receives and starts to measure SRS at tu2.

Given that, the RTT determined at or after tu2 as RTT from gNB view=(tu2−td0)−(tu0−td2) and the practical RTT from satellite view=(tu1−td1)−(tu0−td2), which is for UE positioning. It is worth noting that the timing sequence depicted in FIG. 11 is one of the definitions of RTT; however, there may be other definitions to get RTT but the basic rationale of RTT is the same and embodiments of the present disclosure can be applied.

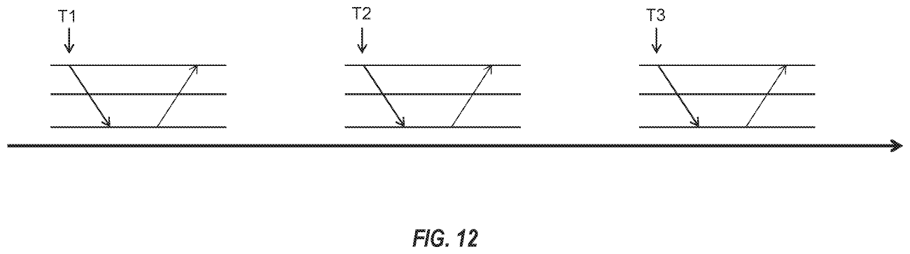

The time sequence of FIG. 11 is repeated plurally, represented by at least T1, T2 and T3, e.g. starting or ending or triggering or initiating at least T1, T2 and T3 shown in FIG. 12, wherein T1 indicates when to start or end or trigger or initiate the first RTT measurement occasion, T2 indicates when to or end or trigger or initiate the second RTT measurement occasion, and so on within one full multi-RTT measurement. In one example, T1 is equal to td0, td1, td2, tu0, tu1, or tu2 depending on different views. The time sequence with respect to T1, T2, and T3 is often used even when more appropriate terms would be positioning measurement sequence, set of positioning measurement, positioning measurement set, repeating positioning measurement and so on.

To estimate the UE location using the RTT measurements, it is important to at least know the location of the TRP/satellite node transmitting the PRS resource(s) based on which the UE performs UE Rx-Tx time difference measurement, i.e., tu2 and td0 in the RTT equation above. For this, in the NR multi-RTT positioning where TRPs are deployed at fixed locations, providing DL-PRS ID that is unique to a TRP in the assistance data is enough as it is supported today by NR positioning specification for multi-RTT positioning method. However, in the context of NTN where single satellite node is to be used for UE position estimation, due to the mobile nature of the satellite node, the LMF needs to provide time instances when the UE shall perform Rx-Tx time difference measurement. LMF can also provide similar assistance data to the satellite node to help it perform meaningful Rx-Tx time difference measurement for UE position estimation. Therefore, due to the mobile nature of satellite node transmitting PRS resource(s), conversion of RTT to distance/range for position estimation from satellite point of view shall be done as:

$${Range}_{sat - ue} = [ Pue ( tu 1 ) - Psat ( td 1 ) ] / 2 c - [ Pue ( tu 0 ) - Psat ( td 2 ) ] / 2 c .$$

For this equation to work, the assistance data to the UE shall include, for example, td1 as time instance, when it shall perform positioning measurement on DL PRS resource(s) transmitted by the satellite node. The assistance data to UE shall also include, for example tu0 as time instance, to configure UE to start transmission of SRS resource(s) for positioning measurement(s). It shall also be noted that the variable Pue in the equation above denotes the location of target UE which is estimated by exploiting multiple RTT measurements.

Embodiments of the proposed solution disclosed herein try to solve the following issues that appear when exploiting legacy multi-RTT method for single satellite node based multi-RTT positioning for network verified UE location in NTN.

Issue 1: The satellite may move between the time when the satellite transmits the corresponding PRS signal and the time when the satellite receives the corresponding SRS signal due to the Earth's rotation, due to the satellite and UE movement, and due to the time interval/duration on RTT measurement. The satellite and UE positions are not a constant and cause error of RTT positioning. Especially, the satellite position error dominates since the moving speed of the satellite is substantially higher than that of the UE. In such case, which location of the satellite during this period should be used as input to the multi-RTT algorithm is unclear. As shown in FIG. 10, the satellite may move between td1 and tu1. It is unclear what location of the satellite during this period should be used as input to the multi-RTT algorithm.

Issue 2: Multi-RTT positioning with a single satellite may take an extremely long time, e.g. totally 30 seconds with respect to 3 times RTT measurement and 10 seconds measurement period. The position of the satellite when each measurement is made is vital to UE position calculation, e.g. the position of the satellite at time td1 when satellite transmits PRS to UE or time tu1 when satellite transmits SRS to gNB is vital to UE position calculation. The LMF cannot acquire accurate estimates of the satellite's position when the measurements occur based only on ephemeris data, e.g., cannot acquire accurate estimates of the satellite's position at td1 and tu1 only based on ephemeris data; consequently, the accuracy of calculation on UE position is degraded. In the worst case, when LMF initiates or triggers positioning acquisition at TO, the LMF may use T0 as the time instance to assess satellite position with respect to satellite ephemeris data at T0; however the exact measurements occurs at T1, T2, and T3, and the satellite position shall follow satellite ephemeris data at T1, T2, and T3 (i.e., the position of the satellite in accordance with the ephemeris data at T0 is not necessarily an accurate estimation of the satellite's position at T1, T2, and T3). The position error/offset of satellite in turn is (T1−T0), (T2−T0) and (T3−T0), those error/offset also is embedded in multi-RTT positioning calculation. Therefore, it is necessary to study the above issue and develop corresponding solutions.

Issue 3: Existing Radio Access Technology (RAT) dependent positioning methods which have been designed for Terrestrial Network (TN) as described in Section 2.3 above) are expected to be reused for network verified UE location in NTN network. In this case, necessary adaptation or enhancements would be needed to improve the existing RAT dependent positioning methods considering the differences (e.g., topology and deployment scenarios) between TN and NTN. Due to the involvement of the satellite in NTN, the existing signaling and interfaces between the LMF and the UE and between the LMF and the gNB would be insufficient. Specifically, multiple time instants (e.g., T1, T2, and T3) need to be signaled/configured to the UE and the gNB so that positioning measurements can be performed by the UE and the gNB at these time instants. The signaling details need to be defined. In addition, how to determine these time instants by the LMF is also unclear. This is an important issue to be addressed since the positioning accuracy is expected to be affected by locations of these time instants and the gap between two consecutive time instants.

Certain aspects of the disclosure and their embodiments may provide solutions to these or other challenges. Embodiments of the present disclosure enable an LMF to take the mobile nature of a TRP transmitting PRS into account for provisioning of assistance data to a UE for positioning measurement for multi-RTT based network verified UE location in NTN. In one embodiment, multi-RTT based positioning, where multiple-TRPs at fixed location transmit PRS resource(s) for positioning measurement, is adapted to a single satellite/node based solution, where a single node (not deployed at a fixed location) is configured to transmit PRS resource(s).

Embodiments of the present disclosure may include one or more of the following features:
1. Assistance data from LMF to UE for positioning measurement in an NTN considers distance between the satellite and the UE and provides time stamps to network node or/and UE when network node or/and UE is/are to perform positioning measurements, such as RTT, to report back to LMF. Alternatively, network node or/and UE provide time stamps to LMF that indicate when they performed reported positioning measurements together with positioning measurement report to LMF.
2. The time stamps used by LMF or network node or UE to indicate to network node or/and UE when to perform positioning measurement such as RTT are based on the propagation delay of a reference signal for positioning measurement. The propagation delay depends on the altitude where the satellite node transmitting the reference signal for positioning measurement is deployed.
3. LMF also considers UE processing capability (e.g., in terms of number of symbols it can process per time unit) to configure UE with UL transmission time stamps indicating start of transmission of uplink reference signal for positioning measurements.
4. LMF takes distance between UE and satellite receiving positioning reference signal in uplink and the time when the uplink positioning reference signal was transmitted by the UE to compensate for the reference signal propagation delay to estimate the UE location based on the UE reported measurement such as RTT.

Certain embodiments may provide one or more of the following technical advantage(s). In a cellular network, TRPs are deployed at fixed locations. In such a deployment (shown in FIG. 9), during a positioning procedure, it is enough for the LMF to provide assistance data that can be used by the UE to understand which positioning reference signal (PRS) is transmitted by which TRP and perform the positioning measurements. Such positioning measurements are then reported by the UE to the LMF. LMF then uses the UE reported measurements to estimate the UE location.

In contrast to the cellular network, in an NTN, there is only one satellite node transmitting PRS resource(s). In such a deployment (as shown in FIG. 10), UE performs positioning measurements on the PRS transmitted by the same satellite at different time instances. Since satellite nodes are continuously moving, performing positioning measurements on the PRS resource(s) transmitted by the same satellite at different times can be treated equivalently to the PRS resource(s) transmitted by static TRPs at different locations. Such measurements can then be used to localize a UE on the ground.

To ensure the current NR positioning framework is relevant for UE positioning in NTN, some changes to LPP are needed. In one embodiment, one of the changes to LPP is to include time information in the assistance data that acts as a stamp on timeline when the UE is expected to perform positioning measurement on the PRS resource(s) transmitted by the same satellite node over different time instances and when the UE is expected to start transmission of uplink reference signal for positioning, such as SRS for positioning, that can then later be used in the position estimation by LMF by compensating for the impact of propagation delay on the estimated uplink time of arrival (ToA). Such a timeline is defined by the LMF, as the LMF is the entity within the NTN that bears the information on satellite node deployment (including its distance to UE and velocity) and therefore can effectively derive the information that needs to be included in the assistance data and the information that can be used to compensate for the impact of signal propagation delay in an NTN on positioning measurements such as ToA.

The ultimate benefits of the proposed solution can therefore be summarized as:
LPP is updated to make it relevant for single satellite node based multi-RTT positioning to localize a UE on the ground.
LMF is enabled to make necessary corrections to UE reported positioning measurements in single satellite node based multi-RTT positioning in an NTN.

In the following description, FIG. 10 is considered as an example of an NTN where during a positioning procedure a UE (e.g., on the ground) is to be localized. In FIG. 10, there is a single satellite node deployed at an altitude of x kilometers (km) above ground. A LMF is aware of the satellite node deployment information such as, e.g., altitude, velocity, etc. The single satellite node transmits PRS resources from different locations at different time instances. Satellite locations at four different time instances are considered in FIG. 10. “Location at T1” denotes location of the satellite node at time instance T1 when it transmits its first PRS resource(s). “Location at T2” denotes location of the satellite node at time instance T2 when it transmits its second PRS resource(s). “Location at T3” denotes location of the satellite node at time instance T3 when it transmits its third PRS resource(s). “Location at T4” denotes location of the satellite node at time instance T4 when it transmits its fourth PRS resource(s). The four time instances in FIG. 10 follow the order T4>T3>T2>T1. The satellite node is at four different locations at the four time instances, and the PRS resource at each time instant can be received by the UE and used by the UE to perform positioning measurements.

Sorting out all multi-RTT related timing parameters in Table 2 below with respect to the content in Section 3.1 of the Introduction above, for each measurement occasion, e.g. starting or ending or triggering or initiating at least at T1, T2, and T3, there is a set or sequence of time instances tu1, td1, tu0, and td2 which represent the time instances when the uplink and downlink reference signals are transmitted/received at different interfaces. In other words, each of the time instances in the measurements at T1, T2, and T3 have corresponding time instances tu1, td1, tu0, and td2 at which the uplink and downlink reference signals are transmitted/received at different interfaces.

TABLE 2
Time instance in multi-RTT

| Time instance representing | Time instance representing |
|---|---|
| each measurement occasion | RS at different interface |
| T1 | Tu1, Td1, Tu0 and Td2 |
| T2 | Tu1, Td1, Tu0 and Td2 |
| T3 | Tu1, Td1, Tu0 and Td2 |
| . . . | . . . |

In one example, each of T1, T2, and T3 is formatted as an absolute time instance, e.g. 00:00:00. In another example, each of T1, T2, and T3 is formatted as relative time instance to one unified time reference, e.g. System Frame Number (SFN).

In the same manner, in one example, tu1, td1, tu0, and td2 (for each of T1, T2, and T3) are formatted as absolute time instances e.g. 00:00:00. In another example, tu1, td1, tu0, and td2 (for each of T1, T2, and T3) are formatted as relative time instances to one unified time reference, e.g. T1, T2, or T3, respectively.

The time instances tu1, td1, tu0, and td2 in the first measurement occasion at T1 are also referred to as tu1, td1, tu0, and td2 in T1; tu1, td1, tu0, and td2 in the second measurement occasion at T2 are also referred to as tu1, td1, tu0, and td2 in T2; and so on.

In some embodiments of the present disclosure, an update to assistance data in LPP is provided. In an NTN (e.g., the NTN of FIG. 10), the LMF is aware of the satellite node deployment (including, but not limited to, altitude of deployment and velocity) information. The LMF is also aware of the configuration(s) of the PRS resource(s) to the satellite node. Based on the satellite deployment information, the LMF calculates a propagation delay of the PRS resource from the satellite node to the UE (e.g., on ground). Based on this information, the LMF then derives when (i.e., derives time instance(s) at which) the UE is to expect to receive the PRS resource(s) from the satellite node and perform a positioning measurement using the PRS. The derived time instances may be indicated by respective time stamps. In some embodiment, the LMF knows the processing capability of the UE and considers this information when deriving the time stamps to identify the time instances in the positioning timeline when the UE is to expect to receive the PRS resource(s) from the satellite node and when the UE is to initiate transmission of SRS resource(s) for positioning to be received by the satellite node. The LMF provides this timing information (i.e., the time stamps) to the UE in assistance data (in LPP assistance data) to facilitate positioning measurement based on the PRS resource(s) transmitted by the single (mobile) satellite node for multi-RTT based positioning.

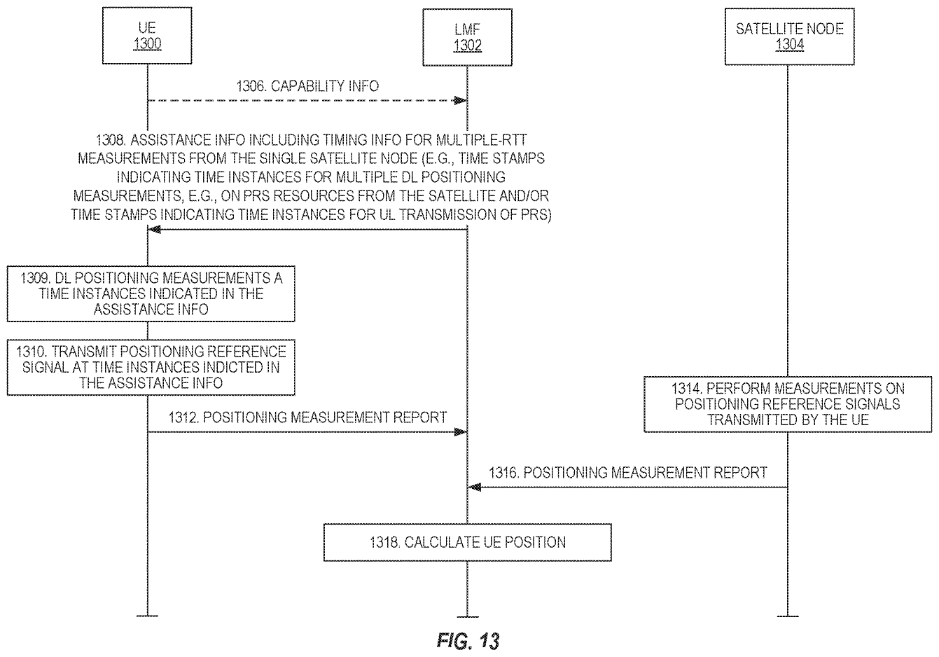

In this regard, FIG. 13 illustrates the operation of a UE 1300, an LMF 1302, and a satellite node 1304 in an NTN for multi-RTT based positioning using a single satellite node, in accordance with one example embodiment of the present disclosure. Optional steps are represented by dashed lines/boxes. As illustrated, the UE 1300 optionally sends capability information to the LMF 1302, where this capability information indicates that the UE 1300 is capable of multi-RTT based positioning using a single satellite node or single TRP (step 1306). The LMF 1302 sends, to the UE 1300, assistance information including timing information for multi-RTT measurements from a single satellite node (i.e., the satellite node 1304) (step 1308). In one embodiment, the timing information includes information that indicates multiple time instances at which the UE 1300 is to perform downlink measurements on downlink PRS (or PRS resources) from the satellite node 1304 and/or information that indicates multiple time instances at which the UE 1300 is to transmit uplink reference signals (e.g., SRS) to the satellite node 1304. In one embodiment, this timing information is in the form of time stamps that indicate the respective time instances (e.g., T1, T2, T3 in the example of FIG. 10). In one embodiment, the assistance information of step 1308 is sent via an updated or modified LPP signaling.

The UE 1300 performs downlink positioning measurements (e.g., on DL PRS or PRS resources from the satellite node 1304) at the time instances indicated by the assistance information for downlink positioning measurements (step 1309). The UE 1300 also transmits uplink positioning reference signals (e.g., SRS) at the time instances indicated by the assistance information for uplink reference signal transmission (step 1310). The UE 1300 also sends a measurement report to the LMF 1302 that includes the downlink positioning measurements performed in step 1309).

The satellite node 1304 performs positioning measurements on the uplink positioning reference signals (e.g. SRS) from the UE 1300 (step 1314) and sends a measurement report including these positioning measurements to the LMF 1302 (step 1316). The LMF 1302 calculates the position of the UE 1300 based on the positioning measurements receives from the UE 1300 and the positioning measurements received from the satellite node 1304 (step 1318).

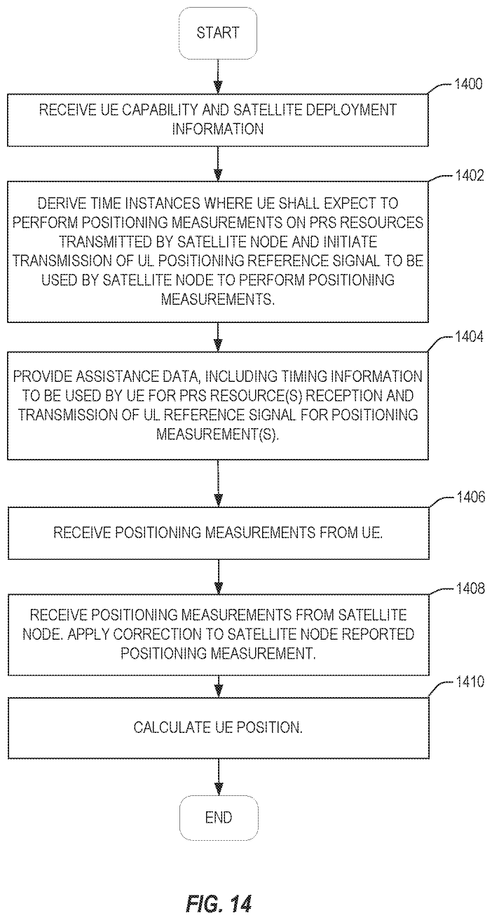

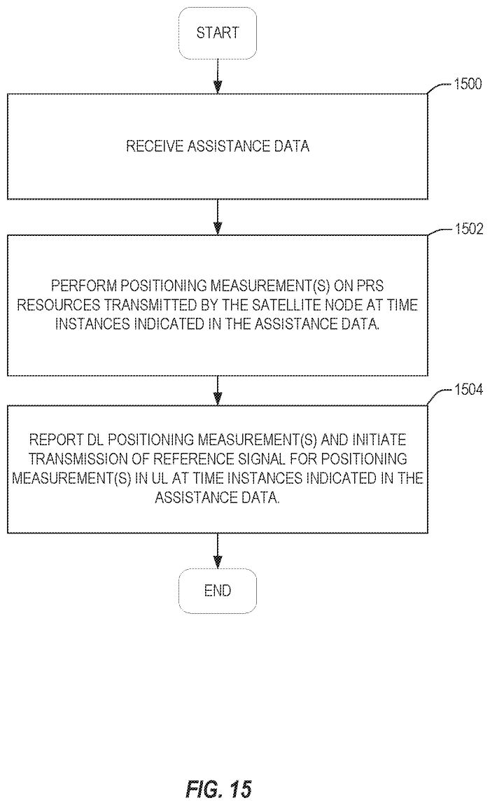

Further details of the steps of the procedure of FIG. 13 are provided below with respect to the flow charts of FIG. 14 (method performed by the LMF 1302) and FIG. 15 (method performed by the UE 1300).

FIG. 14 is a flow chart that illustrates the operation of the LMF 1302 in accordance with one embodiment of the present disclosure. Step 1400 corresponds to step 1306 of FIG. 13, steps 1402 and 1404 correspond to step 1308 of FIG. 13, step 1406 corresponds to step 1312 of FIG. 13, step 1408 corresponds to step 1316 of FIG. 13, and step 1410 corresponds to step 1318 of FIG. 13. Each of the steps of FIG. 14 are described as follows:

Step 1400: The LMF 1302 receives the capability information from the UE 1300 and also receives or otherwise obtains deployment information for the satellite node 1304 (e.g., from the satellite node 1304 or from some other network node). In this step, the LMF 1302 receives UE capability in terms of its PRS processing capability and ability to support multi-RTT positioning. In this step, the LMF 1302 also receives satellite node deployment information that allows the LMF 1302 to understand altitude and velocity of the deployed satellite node 1304.

Step 1402: The LMF 1302 derives the assistance information that is to be provided to the UE 1300 to support single node based multi-RTT positioning. This assistance information derived by the LMF 1302 at this stage includes the time instances when the UE 1300 is to expect to receive PRS resource(s) transmitted by the satellite node 1304 and perform the positioning measurement(s) on the received PRS resource(s). The LMF 1302 also considers the UE PRS processing capability and the satellite deployment information to derive the time instances when the UE is to start transmission of positioning reference signal (e.g., SRS) for positioning measurement(s) in UL direction at the satellite node 1304.

In one example, the LMF 1302 signals or sends T1 to gNB and/or UE 1300. In other words, in one embodiment, the assistance information includes information (e.g., a time stamp) that indicates T1 (i.e., the time instance when the first positioning measurement is to be performed, see, e.g., FIG. 10).

In one example, T2, T3 and so on can be derived from T1 and measurement occasion periodicity which is pre-defined or configured by LMF or gNB. In other words, in one embodiment, the assistance information includes information (e.g., a time stamp) that indicates T1, but does not include information that directly indicates the other time instances T2, T3, etc. (time instances of the second measurement, third measurement, etc., see, e.g., FIG. 10). The UE 1300 can then derive T2, T3, etc. using a predefined or configured measurement occasion periodicity relative to T1 (e.g., T2=T1+periodicity; T3=T1+(2*periodicity); etc.).

In one example, T2, T3 and so on shall follow same way as T1 to be transmitted from LMF to gNB and/or UE. In other words, in another embodiment, the assistance information includes information (e.g., time stamps) that indicates T1, T2, T3, etc. Thus, the assistance information includes information that directly indicates the multiple time instances (e.g., T1, T2, T3, etc.) at which the UE 1300 is expected to receive the DL PRS resources and perform positioning measurements based thereon.

In another example, corresponding to T1, T2, T3 . . . , the LMF signals or provides td1, tu0, or td2 to gNB and/or UE. In other words, in another embodiment, the assistance information includes information that indicates td1, tu0, or td2 for at least one of the measurement occasions (e.g., for at least one of T1, T2, T3, etc.).

In another example, one or of Tu1, Td1, Tu0, or td2 or function of Tu1, Td1, Tu0 and td2 is derived by T1, T2, T3. For one example, the LMF 1302 provides T1 (in the assistance information) and gNB or UE starts transmitting or receiving at least earlier than a threshold TH2, e.g. Tu1 (in first measurement occasion)<(T1+TH3); Tu1 (in second measurement occasion)<(T2+TH3) and so on.

In another example, T1, T2, T3, together with Tu1, Td1, Tu0 or td2 in each measurement occasion are provided by the LMF 1302 (in the assistance information) and sent to gNB or UE.

### #Derivation of Time Instances to Facilitate UE Receive PRS Resource(s) Transmitted by a Satellite Node at a Given Time Instant

Assuming that the satellite node 1304 in the NTN is deployed at an altitude of x km from Earth, the LFM 1302 can estimate the propagation time of the PRS resource(s) from the satellite node 1304 to the UE 1300 on Earth. The propagation delay (PD) can be derived as PD=x*10³/3*10⁸ s. In the assistance information sent to the UE 1300, the LMF 1302 can use this value to configure the UE 1300 to perform positioning measurement(s) on PRS resource(s) transmitted by satellite at time T1 at Trx1 provided LMF signals or sends T1 to gNB and/or UE. One example of such a calculation can be:

$$Trx 1 = T 1 + PD .$$

Trx1 depends on the range between the satellite transmitting the PRS resource(s) and the UE performing positioning measurement on those PRS resource(s).

### #Derivation of Time Instances to Configure UL Reference Signal for Positioning Transmission Time to UE

In the assistance data, the LMF 1302 also configures the UE 1300 with the time instances when the UE 1300 is to start transmission of reference signal for positioning in UL for the satellite node 1304 to perform positioning measurement(s) for RTT calculation. The LMF 1302 can derive such time instances based on the UE PRS processing capability, time instance when UE 1300 is configured to expect and receive PRS resource(s), and the propagation delay of the PRS resource(s) from the satellite node 1304 to the UE 1300 on Earth. One example of such a calculation could be:

$$Ttx 1 = Trx 1 + UE PRS processing duration .$$

Step 1404: The LMF provides the assistance data to the UE 1300 to configure time instances for reception of PRS resource(s) transmitted by the satellite node 1304 and to configure time instances for transmission of UL reference signal for positioning measurements to be performed by the satellite node 1304. For example, the LMF 1302 provides time instances such as td1, td2, and tu0 as shown in FIG. 11.

Step 1406: The LMF 1302 receives the positioning measurement(s) performed by the UE 1300.

Step 1408: The LMF 1302 receives positioning measurement(s) performed by the satellite node 1304. In this step, the LMF 1302 applies correction(s) to the measurement(s) performed by the satellite node 1304. LMF derives correction to be applied based on the satellite deployment information and the estimated PD in step 1402.

Step 1410: The LMF 1302 calculates the position of the UE 1300 based on the positioning measurements received in Steps 1406 and 1408.

### #RTT Calculation Performed by LMF

Due to the movement of satellite node 1306 transmitting PRS resource(s) for DL positioning measurement and performing positioning measurement(s) on UL reference signal transmitted by UE, the RTT calculation, in contrast to RTT calculation in a terrestrial network, needs to be rectified against the displacement of the satellite node 1304 when PRS resource(s) transmission starts and received/measured by the UE 1300, and when the UE 1300 starts transmission of UL reference signal for positioning and is received/measured by the satellite node 1304. Correction applied is the reference to satellite position at td1 but not at td2. Satellite position at td2 due to the constant velocity with which the satellite is moving.

$${Range}_{sat - ue} = [ Pue ( tu 1 ) - Psat ( td 1 ) ] / 2 c - [ Pue ( tu 0 ) - Psat ( td 2 ) ] / 2 c .$$

FIG. 15 is a flow chart that illustrates the operation of the UE 1300 in accordance with one embodiment of the present disclosure. Step 1500 corresponds to step 1308 of FIG. 13, step 1502 corresponds to step 1309 of FIG. 13, step 1504 corresponds to steps 1310 and 1312 of FIG. 13. Each of the steps of FIG. 15 are described as follows:

Step 1500: In this step, the UE 1300 receives assistance data from the LMF 1302. The assistance data contains the time instances indicating when to perform positioning measurement(s) on the DL-PRS resource(s) transmitted by the satellite node 1304 and start transmitting reference signal resource(s) in UL to be measured by the satellite node Y404. For example, the LMF 1302 provides set(s) of time instances in each measurement occasion such as T1, T2, T3 or/and td1, td2, and tu0 in each measurement occasion as shown in FIG. 11.

Step 1502: In this step, the UE 1300 performs positioning measurements at the LMF 1302 configured time instance(s). For multiple RTT measurements, the LMF 1302 may configure the UE 1300 to perform RTT measurements on DL-PRS resource(s) transmitted by the same satellite node 1304 from different location(s) in terms of time instances.

In one example, upon receiving assistance information signaled by the LMF 1302, the UE 1300 starts the measurement before or not later than a threshold TH4 after the signaled time instances indicating when to perform positioning measurement(s), e.g. measurement shall be started not later than (T1+TH4) provided T1 is indicated by assistance information signaled by the LMF 1302.

In another example, upon receiving assistance information signaled by the LMF 1302, the UE 1300 ends the measurement before or not later than a threshold TH5 after the signaled time instances indicating when to perform positioning measurement(s), e.g. measurement shall be ended not later than (T1+TH5) provided T1 is indicated by assistance information signaled by the LMF 1302. Otherwise, the multi-RTT measurement is invalid, and the UE 1300 report failure of multi-RTT measurement. Consequently, the UE 1300 requests and acquires assistance data from the LMF 1302 again to restart Multi-RTT measurement.

Step 1504: In this step, the UE 1300 reports the measurement to the LMF 1302 and starts transmitting SRS resource(s) for positioning measurement(s) to be performed by the satellite node 1304. In one embodiment, the UE 1300 accumulates the DL measurement(s) and reports them to the LMF 1302 along with the time instances (e.g. Tu1, Td1, Tu0 or td2) it considered for positioning measurement(s) after it completes final transmission of SRS resource(s) in UL direction based on the time instance configuration received from the LMF 1302.

In one example, T1, T2, T3 . . . are derived by one or of Tu1, Td1, Tu0 or td2 or function of Tu1, Td1, Tu0 and td2 in each measurement occasion. For example, the first Td1 UE reported is treated as T1 and is utilized by LMF 1302, the second Td1 UE reported is treated as T2 and is utilized by LMF 1302 and so on.

In another example, one or of Tu1, Td1, Tu0 or td2 or function of Tu1, Td1, Tu0 and td2 is derived by T1, T2, T3. For one example, gNB or UE reports T1 which can approximately represent one of Tu1, Td1, Tu0 or td2 in T1 if T1 and one of Tu1, Td1, Tu0 or td2 meet certain proximity condition or threshold, e.g. (Tu1 (in first measurement occasion)−T1)<TH1; (Tu1 (in second measurement occasion)−T2)<TH2 and so on.

In another example, T1, T2, T3, together with Tu1, Td1, Tu0 or td2 in each measurement occasion are provided by gNB or UE and sent to LMF.

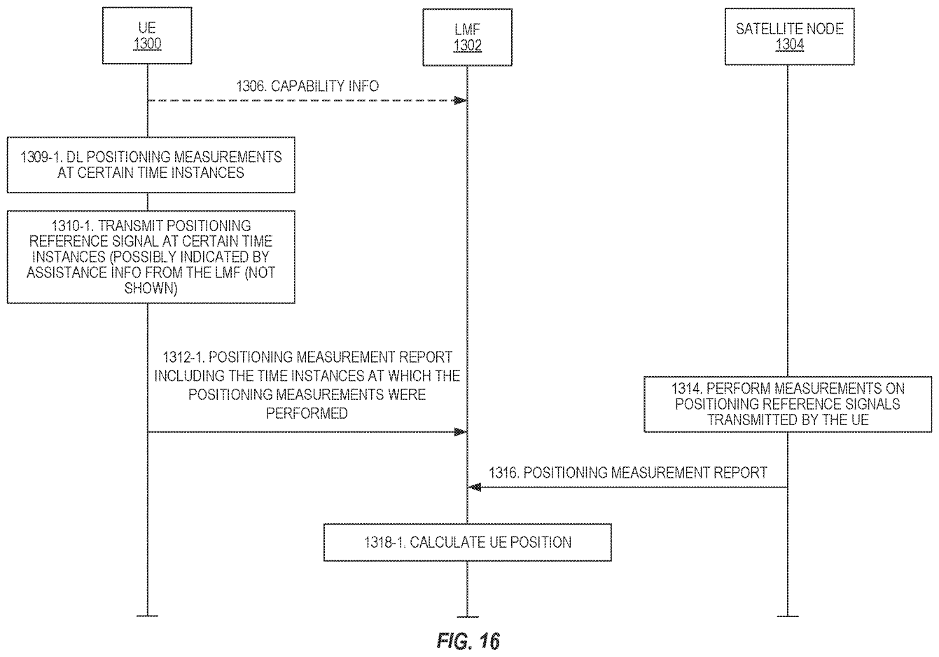

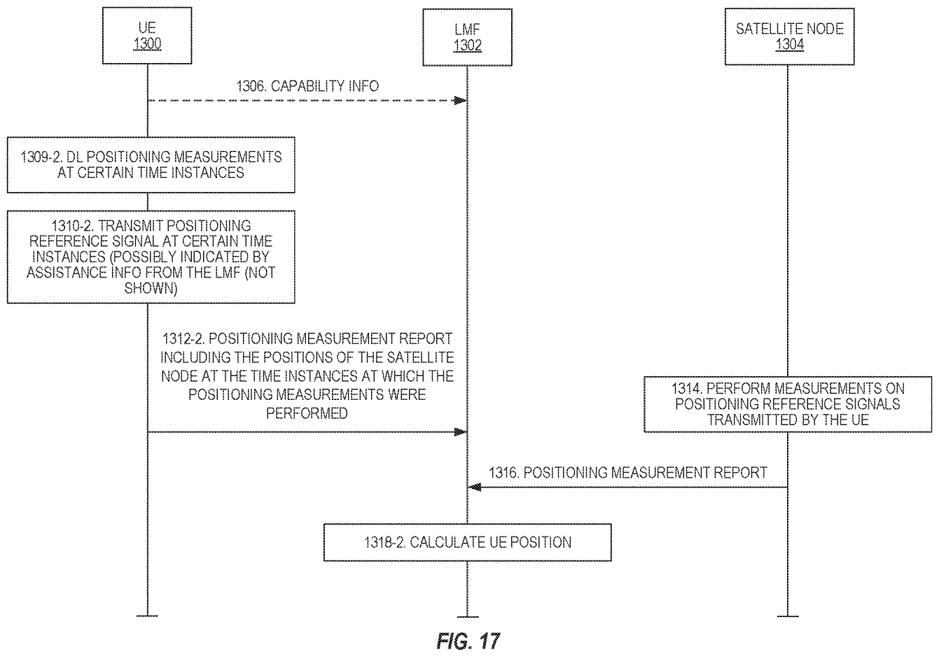

FIGS. 13, 14, and 15 relate to an example embodiment in which the LMF 1302 provides the aforementioned assistance information to the UE 1300. In an alternative embodiment, rather than the LMF 1302 providing the timing information (e.g., time instances when the UE 1300 is to expect to receive PRS from the satellite node and when the UE 1300 is to start transmission of SRS to the satellite node 1304), the UE 1300 instead provides information that indicates the time instances at which the downlink positioning measurements were performed by the UE 1300 together with the downlink positioning measurements in step 1312 (i.e., in this case step 1308 is not performed or alternatively the assistance information sent in 1308 does not include the timing information for multi-RTT positioning). This alternative is illustrated in FIG. 16 where modified versions the corresponding steps of FIG. 13 are indicated with a “1” after their reference numbers. As yet another alternative, the UE 1300 may instead provide information that indicates the position of the satellite node 1304 at the time instances at which the downlink positioning measurement were performed by the UE 1300 together with the downlink positioning measurements in step 1312 (i.e., in this case step 1308 is not performed or alternatively the assistance information sent in 1308 does not include the timing information for multi-RTT positioning). This alternative is illustrated in FIG. 17 modified versions of the corresponding steps of FIG. 13 are indicated with a “2” after their reference numbers.

Some example embodiments of the present disclosure are as follows:

### Embodiments on UE and the gNB:

In a first embodiment, an NTN UE provides the information on the satellite's location in addition to the positioning measurement results to the LMF or the location server.
The measurement results reported by the UE would depend on the positioning method. In other words, different information is included for different positioning methods.
In case of multi-RTT positioning method, the measurement results include UE RX-TX time difference measurement and other information as captured in clause 8.10.2.2 of TS 38.305 V 17.3.0)

In a second embodiment, the information on the satellite's location provided by the UE to the LMF or the location server may comprise at least one of the following information elements:
Time when the satellite receives or transmits the corresponding PRS signal for the positioning measurement results.
Time when the satellite receives or transmits the corresponding SRS signal for the positioning measurement results
Time when the gNB transmits the PRS signal for the positioning measurement results
Time when the gNB receives the SRS signal for the positioning measurement results
Time when the UE receives the PRS signal for the positioning measurement results
Time when the UE transmits the SRS signal for the positioning measurement results
Time indicating starting or triggering each measurement occasion, e.g. T1, T2 or T3.
Propagation delay between the satellite and the UE
Propagation delay between the gNB and the UE
Propagation delay between the satellite and the gNB
Timing advance applied by the UE

Alternatively, the information may comprise any time between the time when the satellite transmits the corresponding PRS signal and the time when the satellite receives the corresponding SRS signal (e.g., the median time between the time when the satellite transmits the corresponding PRS signal and the time when the satellite receives the corresponding SRS signal).

Alternatively, the information may comprise any time between the time when the gNB transmits the corresponding PRS signal and the time when the gNB receives the corresponding SRS signal (e.g., the median time between the time when the gNB transmits the corresponding PRS signal and the time when the gNB receives the corresponding SRS signal).

In a third embodiment, the gNB provides the information on the satellite's location in addition to the positioning measurement results to the LMF or the location server.
The measurement results reported by the gNB would depend on the positioning method. In other words, different information is included for different positioning methods.
In case of multi-RTT positioning method, the measurement results include gNB RX-TX time different measurement and other information as captured in clause 8.10.2.3 of TS 38.305 V 17.3.0)

In a fourth embodiment, the information on the satellite's location provided by the gNB to the LMF or location server may comprise a part or same information as what the UE has provided to the LMF/location server (as described in the second embodiment).

In a fifth embodiment, the UE provides positioning measurement results and/or the information on the satellite's location in a signaling/message of a positioning protocol (e.g., LPP).

In a sixth embodiment, the gNB provides positioning measurement results and/or the information on the satellite's location in a signaling/message of a positioning protocol (e.g., NRPPa).

In a seventh embodiment, the UE receives indication of multiple time instances in assistance data. The time instances refer to time instants when UE is expected to perform positioning measurement(s) on DL-PRS resource(s), where every time instant maps to a unique satellite position. In the same manner, multiple time instances in the assistance data are used by the UE to perform transmission of SRS resource(s) for positioning measurement(s) to be performed by the satellite node. UE may also receive a set of time instances to start performing positioning measurement(s) on DL-PRS resource(s) transmitted by satellite node and a set of time instances when it shall start transmission of UL SRS resource(s) to be measured by satellite node. In this case, UE selects a sub-set of time instances to perform positioning measurements on DL-PRS resource(s) transmitted by the satellite node and reports them to LMF along with the measurement(s). In addition, we select a sub-set of instances when it transmits SRS resource(s) for positioning measurement(s) to be performed by the satellite node.

### Embodiments to LMF or Location Server

In one embodiment, when the LMF/location server receives position measurement results and/or the information on the satellite's location from the UE and/or the gNB, the LMF/location server derives the UE's location based at least one of the below information as inputs to the location algorithm
The positioning measurement results for one or multiple time instants
   The measurement results would depend on the positioning method. In other words, different information is included for different positioning methods.
   In case of multi-RTT positioning method, the measurement results include UE RX-TX time different measurement and other information as captured in clause 8.10.2.2 of TS 38.305 V 17.3.0)
   In case of multi-RTT positioning method, the measurement results include gNB RX-TX time different measurement and other information as captured in clause 8.10.2.3 of TS 38.305 V 17.3.0).
The information on the satellite's location at one or multiple time instants

In one embodiment, the LMF consumes the below Assisted GNSS information to determine the satellite position. Typically, this information is provided to UE for facilitating UE to compute its location using A-GNSS positioning method. However, for the multi-RTT the LMF would consume to determine the satellite location and also a projected location at time T1, T2 and T3 where UE is configured to perform the measurements or transmit UL-SRS.

Assistance Data

Reference Time
Reference Location
Ionospheric Models
Earth Orientation Parameters
Differential GNSS Corrections

Reference Time assistance provides the GNSS receiver with coarse or fine GNSS time information. The specific GNSS system times (e.g., GPS, Galileo, GLONASS, BDS, NavIC system time) shall be indicated with a GNSS ID.

Reference Location assistance provides the GNSS receiver with an a priori estimate of its location (e.g., obtained via Cell-ID, OTDOA positioning, etc.) together with its uncertainty.

Ionospheric Model assistance provides the GNSS receiver with parameters to model the propagation delay of the GNSS signals through the ionosphere.

Differential GNSS Corrections assistance provides the GNSS receiver with pseudo-range and pseudo-range-rate corrections to reduce biases in GNSS receiver measurements as specified.

Ephemeris and Clock Models assistance provides the GNSS receiver with parameters to calculate the GNSS satellite position and clock offsets.

Based upon the above information LMF computes the satellite current location and expected location based upon above info and satellite trajectory information. It can also use historical information (e.g. last day) information to identify where the satellite would be at a certain time.

The ionospheric, atmospheric delay information is used by LMF to compute the propagation delay. Further, UE capability to process DL-PRS measurements can indicate how long will the measurement duration be. Based upon this information, LMF computes the minimum difference between t1 and t2.

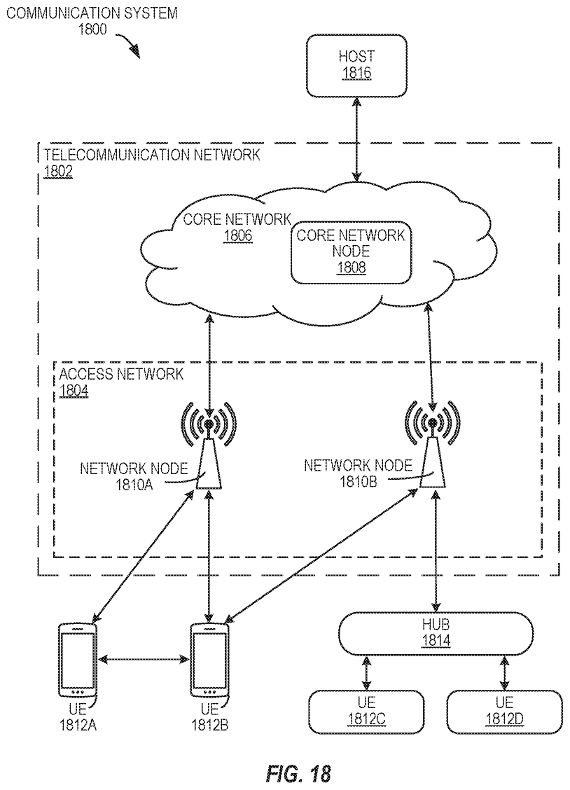

FIG. 18 shows an example of a communication system 1800 in accordance with some embodiments.

In the example, the communication system 1800 includes a telecommunication network 1802 that includes an access network 1804, such as a Radio Access Network (RAN), and a core network 1806, which includes one or more core network nodes 1808. The access network 1804 includes one or more access network nodes, such as network nodes 1810A and 1810B (one or more of which may be generally referred to as network nodes 1810), or any other similar Third Generation Partnership Project (3GPP) access node or non-3GPP Access Point (AP). The network nodes 1810 facilitate direct or indirect connection of User Equipment (UE), such as by connecting UEs 1812A, 1812B, 1812C, and 1812D (one or more of which may be generally referred to as UEs 1812) to the core network 1806 over one or more wireless connections. Note that, in the embodiments described above, the network node Q110 is or includes a satellite node in an NTN deployment.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1800 may include any number of wired or wireless networks, network nodes, UEs, and/or any other components or systems that may facilitate or participate in the communication of data and/or signals whether via wired or wireless connections. The communication system 1800 may include and/or interface with any type of communication, telecommunication, data, cellular, radio network, and/or other similar type of system.

The UEs 1812 may be any of a wide variety of communication devices, including wireless devices arranged, configured, and/or operable to communicate wirelessly with the network nodes 1810 and other communication devices. Similarly, the network nodes 1810 are arranged, capable, configured, and/or operable to communicate directly or indirectly with the UEs 1812 and/or with other network nodes or equipment in the telecommunication network 1802 to enable and/or provide network access, such as wireless network access, and/or to perform other functions, such as administration in the telecommunication network 1802.

In the depicted example, the core network 1806 connects the network nodes 1810 to one or more hosts, such as host 1816. These connections may be direct or indirect via one or more intermediary networks or devices. In other examples, network nodes may be directly coupled to hosts. The core network 1806 includes one more core network nodes (e.g., core network node 1808) that are structured with hardware and software components. Features of these components may be substantially similar to those described with respect to the UEs, network nodes, and/or hosts, such that the descriptions thereof are generally applicable to the corresponding components of the core network node 1808. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-Concealing Function (SIDF), Unified Data Management (UDM), Security Edge Protection Proxy (SEPP), Network Exposure Function (NEF), and/or a User Plane Function (UPF).

The host 1816 may be under the ownership or control of a service provider other than an operator or provider of the access network 1804 and/or the telecommunication network 1802, and may be operated by the service provider or on behalf of the service provider. The host 1816 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1800 of FIG. 18 enables connectivity between the UEs, network nodes, and hosts. In that sense, the communication system 1800 may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable Second, Third, Fourth, or Fifth Generation (2G, 3G, 4G, or 5G) standards, or any applicable future generation standard (e.g., Sixth Generation (6G)); Wireless Local Area Network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any Low Power Wide Area Network (LPWAN) standards such as LoRa and Sigfox.

In some examples, the telecommunication network 1802 is a cellular network that implements 3GPP standardized features. Accordingly, the telecommunication network 1802 may support network slicing to provide different logical networks to different devices that are connected to the telecommunication network 1802. For example, the telecommunication network 1802 may provide Ultra Reliable Low Latency Communication (URLLC) services to some UEs, while providing enhanced Mobile Broadband (eMBB) services to other UEs, and/or massive Machine Type Communication (mMTC)/massive Internet of Things (IoT) services to yet further UEs.

In some examples, the UEs 1812 are configured to transmit and/or receive information without direct human interaction. For instance, a UE may be designed to transmit information to the access network 1804 on a predetermined schedule, when triggered by an internal or external event, or in response to requests from the access network 1804. Additionally, a UE may be configured for operating in single- or multi-Radio Access Technology (RAT) or multi-standard mode. For example, a UE may operate with any one or combination of WiFi, New Radio (NR), and LTE, i.e. be configured for Multi-Radio Dual Connectivity (MR-DC), such as Evolved UMTS Terrestrial RAN (E-UTRAN) NR-Dual Connectivity (EN-DC).

In the example, a hub 1814 communicates with the access network 1804 to facilitate indirect communication between one or more UEs (e.g., UE 1812C and/or 1812D) and network nodes (e.g., network node 1810B). In some examples, the hub 1814 may be a controller, router, content source and analytics, or any of the other communication devices described herein regarding UEs. For example, the hub 1814 may be a broadband router enabling access to the core network 1806 for the UEs. As another example, the hub 1814 may be a controller that sends commands or instructions to one or more actuators in the UEs. Commands or instructions may be received from the UEs, network nodes 1810, or by executable code, script, process, or other instructions in the hub 1814. As another example, the hub 1814 may be a data collector that acts as temporary storage for UE data and, in some embodiments, may perform analysis or other processing of the data. As another example, the hub 1814 may be a content source. For example, for a UE that is a Virtual Reality (VR) headset, display, loudspeaker or other media delivery device, the hub 1814 may retrieve VR assets, video, audio, or other media or data related to sensory information via a network node, which the hub 1814 then provides to the UE either directly, after performing local processing, and/or after adding additional local content. In still another example, the hub 1814 acts as a proxy server or orchestrator for the UEs, in particular in if one or more of the UEs are low energy IoT devices.

The hub 1814 may have a constant/persistent or intermittent connection to the network node 1810B. The hub 1814 may also allow for a different communication scheme and/or schedule between the hub 1814 and UEs (e.g., UE 1812C and/or 1812D), and between the hub 1814 and the core network 1806. In other examples, the hub 1814 is connected to the core network 1806 and/or one or more UEs via a wired connection. Moreover, the hub 1814 may be configured to connect to a Machine-to-Machine (M2M) service provider over the access network 1804 and/or to another UE over a direct connection. In some scenarios, UEs may establish a wireless connection with the network nodes 1810 while still connected via the hub 1814 via a wired or wireless connection. In some embodiments, the hub 1814 may be a dedicated hub—that is, a hub whose primary function is to route communications to/from the UEs from/to the network node 1810B. In other embodiments, the hub 1814 may be a non-dedicated hub—that is, a device which is capable of operating to route communications between the UEs and the network node 1810B, but which is additionally capable of operating as a communication start and/or end point for certain data channels.

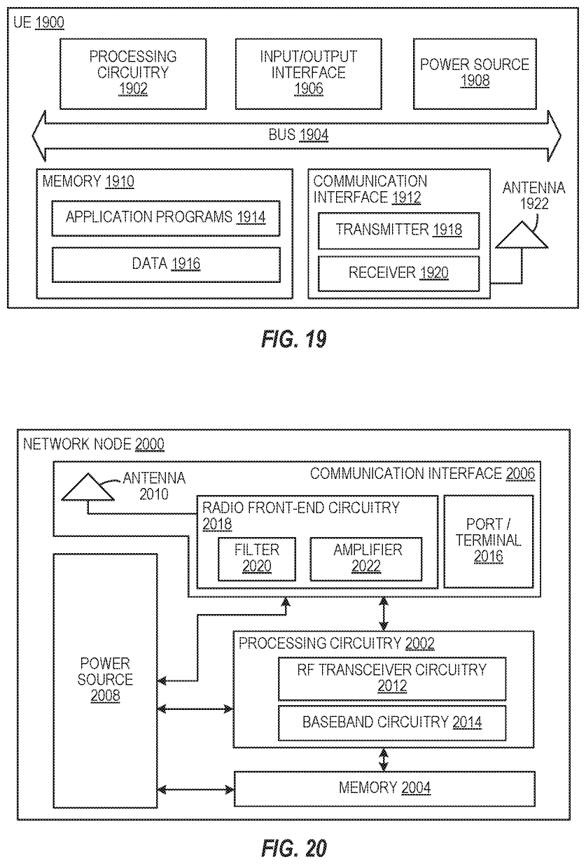

FIG. 19 shows a UE 1900 in accordance with some embodiments. As used herein, a UE refers to a device capable, configured, arranged, and/or operable to communicate wirelessly with network nodes and/or other UEs. Examples of a UE include, but are not limited to, a smart phone, mobile phone, cell phone, Voice over Internet Protocol (VOIP) phone, wireless local loop phone, desktop computer, Personal Digital Assistant (PDA), wireless camera, gaming console or device, music storage device, playback appliance, wearable terminal device, wireless endpoint, mobile station, tablet, laptop, Laptop Embedded Equipment (LEE), Laptop Mounted Equipment (LME), smart device, wireless Customer Premise Equipment (CPE), vehicle-mounted or vehicle embedded/integrated wireless device, etc. Other examples include any UE identified by the 3GPP, including a Narrowband Internet of Things (NB-IoT) UE, a Machine Type Communication (MTC) UE, and/or an enhanced MTC (eMTC) UE.

A UE may support Device-to-Device (D2D) communication, for example by implementing a 3GPP standard for sidelink communication, Dedicated Short-Range Communication (DSRC), Vehicle-to-Vehicle (V2V), Vehicle-to-Infrastructure (V2I), or Vehicle-to-Everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1900 includes processing circuitry 1902 that is operatively coupled via a bus 1904 to an input/output interface 1906, a power source 1908, memory 1910, a communication interface 1912, and/or any other component, or any combination thereof. Certain UEs may utilize all or a subset of the components shown in FIG. 19. The level of integration between the components may vary from one UE to another UE. Further, certain UEs may contain multiple instances of a component, such as multiple processors, memories, transceivers, transmitters, receivers, etc.

The processing circuitry 1902 is configured to process instructions and data and may be configured to implement any sequential state machine operative to execute instructions stored as machine-readable computer programs in the memory 1910. The processing circuitry 1902 may be implemented as one or more hardware-implemented state machines (e.g., in discrete logic, Field Programmable Gate Arrays (FPGAs), Application Specific Integrated Circuits (ASICs), etc.); programmable logic together with appropriate firmware; one or more stored computer programs, general purpose processors, such as a microprocessor or Digital Signal Processor (DSP), together with appropriate software; or any combination of the above. For example, the processing circuitry 1902 may include multiple Central Processing Units (CPUs).

In the example, the input/output interface 1906 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1900. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1908 is structured as a battery or battery pack. Other types of power sources, such as an external power source (e.g., an electricity outlet), photovoltaic device, or power cell, may be used. The power source 1908 may further include power circuitry for delivering power from the power source 1908 itself, and/or an external power source, to the various parts of the UE 1900 via input circuitry or an interface such as an electrical power cable. Delivering power may be, for example, for charging the power source 1908. Power circuitry may perform any formatting, converting, or other modification to the power from the power source 1908 to make the power suitable for the respective components of the UE 1900 to which power is supplied.

The memory 1910 may be or be configured to include memory such as Random Access Memory (RAM), Read Only Memory (ROM), Programmable ROM (PROM), Erasable PROM (EPROM), Electrically EPROM (EEPROM), magnetic disks, optical disks, hard disks, removable cartridges, flash drives, and so forth. In one example, the memory 1910 includes one or more application programs 1914, such as an operating system, web browser application, a widget, gadget engine, or other application, and corresponding data 1916. The memory 1910 may store, for use by the UE 1900, any of a variety of various operating systems or combinations of operating systems.

The memory 1910 may be configured to include a number of physical drive units, such as Redundant Array of Independent Disks (RAID), flash memory, USB flash drive, external hard disk drive, thumb drive, pen drive, key drive, High Density Digital Versatile Disc (HD-DVD) optical disc drive, internal hard disk drive, Blu-Ray optical disc drive, Holographic Digital Data Storage (HDDS) optical disc drive, external mini Dual In-line Memory Module (DIMM), Synchronous Dynamic RAM (SDRAM), external micro-DIMM SDRAM, smartcard memory such as a tamper resistant module in the form of a Universal Integrated Circuit Card (UICC) including one or more Subscriber Identity Modules (SIMs), such as a Universal SIM (USIM) and/or Internet Protocol Multimedia Services Identity Module (ISIM), other memory, or any combination thereof. The UICC may for example be an embedded UICC (eUICC), integrated UICC (iUICC) or a removable UICC commonly known as a ‘SIM card.’ The memory 1910 may allow the UE 1900 to access instructions, application programs, and the like stored on transitory or non-transitory memory media, to off-load data, or to upload data. An article of manufacture, such as one utilizing a communication system, may be tangibly embodied as or in the memory 1910, which may be or comprise a device-readable storage medium.

The processing circuitry 1902 may be configured to communicate with an access network or other network using the communication interface 1912. The communication interface 1912 may comprise one or more communication subsystems and may include or be communicatively coupled to an antenna 1922. The communication interface 1912 may include one or more transceivers used to communicate, such as by communicating with one or more remote transceivers of another device capable of wireless communication (e.g., another UE or a network node in an access network). Each transceiver may include a transmitter 1918 and/or a receiver 1920 appropriate to provide network communications (e.g., optical, electrical, frequency allocations, and so forth). Moreover, the transmitter 1918 and receiver 1920 may be coupled to one or more antennas (e.g., the antenna 1922) and may share circuit components, software, or firmware, or alternatively be implemented separately.

In the illustrated embodiment, communication functions of the communication interface 1912 may include cellular communication, WiFi communication, LPWAN communication, data communication, voice communication, multimedia communication, short-range communications such as Bluetooth, NFC, location-based communication such as the use of the Global Positioning System (GPS) to determine a location, another like communication function, or any combination thereof. Communications may be implemented according to one or more communication protocols and/or standards, such as IEEE 802.11, Code Division Multiplexing Access (CDMA), Wideband CDMA (WCDMA), GSM, LTE, NR, UMTS, WiMax, Ethernet, Transmission Control Protocol/Internet Protocol (TCP/IP), Synchronous Optical Networking (SONET), Asynchronous Transfer Mode (ATM), Quick User Datagram Protocol Internet Connection (QUIC), Hypertext Transfer Protocol (HTTP), and so forth.

Regardless of the type of sensor, a UE may provide an output of data captured by its sensors, through its communication interface 1912, or via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an IoT device, may be a device for use in one or more application domains, these domains comprising, but not limited to, city wearable technology, extended industrial application, and healthcare. Non-limiting examples of such an IoT device are a device which is or which is embedded in: a connected refrigerator or freezer, a television, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or VR, a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1900 shown in FIG. 19.

As yet another specific example, in an IoT scenario, a UE may represent a machine or other device that performs monitoring and/or measurements and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship, an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator and handle communication of data for both the speed sensor and the actuators.

FIG. 20 shows a network node 2000 in accordance with some embodiments. As used herein, network node refers to equipment capable, configured, arranged, and/or operable to communicate directly or indirectly with a UE and/or with other network nodes or equipment in a telecommunication network. Examples of network nodes include, but are not limited to, APs (e.g., radio APs), Base Stations (BSs) (e.g., radio BSs, Node Bs, evolved Node Bs (eNBs), and NR Node Bs (gNBs)).

BSs may be categorized based on the amount of coverage they provide (or, stated differently, their transmit power level) and so, depending on the provided amount of coverage, may be referred to as femto BSs, pico BSs, micro BSs, or macro BSs. A BS may be a relay node or a relay donor node controlling a relay. A network node may also include one or more (or all) parts of a distributed radio BS such as centralized digital units and/or Remote Radio Units (RRUs), sometimes referred to as Remote Radio Heads (RRHs). Such RRUs may or may not be integrated with an antenna as an antenna integrated radio. Parts of a distributed radio BS may also be referred to as nodes in a Distributed Antenna System (DAS).

Other examples of network nodes include multiple Transmission Point (multi-TRP) 5G access nodes, Multi-Standard Radio (MSR) equipment such as MSR BSs, network controllers such as Radio Network Controllers (RNCs) or BS Controllers (BSCs), Base Transceiver Stations (BTSs), transmission points, transmission nodes, Multi-Cell/Multicast Coordination Entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 2000 includes processing circuitry 2002, memory 2004, a communication interface 2006, and a power source 2008. The network node 2000 may be composed of multiple physically separate components (e.g., a Node B component and an RNC component, or a BTS component and a BSC component, etc.), which may each have their own respective components. In certain scenarios in which the network node 2000 comprises multiple separate components (e.g., BTS and BSC components), one or more of the separate components may be shared among several network nodes. For example, a single RNC may control multiple Node Bs. In such a scenario, each unique Node B and RNC pair may in some instances be considered a single separate network node. In some embodiments, the network node 2000 may be configured to support multiple RATs. In such embodiments, some components may be duplicated (e.g., separate memory 2004 for different RATs) and some components may be reused (e.g., an antenna 2010 may be shared by different RATs). The network node 2000 may also include multiple sets of the various illustrated components for different wireless technologies integrated into network node 2000, for example GSM, WCDMA, LTE, NR, WiFi, Zigbee, Z-wave, Long Range Wide Area Network (LoRaWAN), Radio Frequency Identification (RFID), or Bluetooth wireless technologies. These wireless technologies may be integrated into the same or different chip or set of chips and other components within the network node 2000.

The processing circuitry 2002 may comprise a combination of one or more of a microprocessor, controller, microcontroller, CPU, DSP, ASIC, FPGA, or any other suitable computing device, resource, or combination of hardware, software, and/or encoded logic operable to provide, either alone or in conjunction with other network node 2000 components, such as the memory 2004, to provide network node 2000 functionality.

In some embodiments, the processing circuitry 2002 includes a System on a Chip (SOC). In some embodiments, the processing circuitry 2002 includes one or more of Radio Frequency (RF) transceiver circuitry 2012 and baseband processing circuitry 2014. In some embodiments, the RF transceiver circuitry 2012 and the baseband processing circuitry 2014 may be on separate chips (or sets of chips), boards, or units, such as radio units and digital units. In alternative embodiments, part or all of the RF transceiver circuitry 2012 and the baseband processing circuitry 2014 may be on the same chip or set of chips, boards, or units.

The memory 2004 may comprise any form of volatile or non-volatile computer-readable memory including, without limitation, persistent storage, solid state memory, remotely mounted memory, magnetic media, optical media, RAM, ROM, mass storage media (for example, a hard disk), removable storage media (for example, a flash drive, a Compact Disk (CD), or a Digital Video Disk (DVD)), and/or any other volatile or non-volatile, non-transitory device-readable, and/or computer-executable memory devices that store information, data, and/or instructions that may be used by the processing circuitry 2002. The memory 2004 may store any suitable instructions, data, or information, including a computer program, software, an application including one or more of logic, rules, code, tables, and/or other instructions capable of being executed by the processing circuitry 2002 and utilized by the network node 2000. The memory 2004 may be used to store any calculations made by the processing circuitry 2002 and/or any data received via the communication interface 2006. In some embodiments, the processing circuitry 2002 and the memory 2004 are integrated.

The communication interface 2006 is used in wired or wireless communication of signaling and/or data between a network node, access network, and/or UE. As illustrated, the communication interface 2006 comprises port(s)/terminal(s) 2016 to send and receive data, for example to and from a network over a wired connection. The communication interface 2006 also includes radio front-end circuitry 2018 that may be coupled to, or in certain embodiments a part of, the antenna 2010. The radio front-end circuitry 2018 comprises filters 2020 and amplifiers 2022. The radio front-end circuitry 2018 may be connected to the antenna 2010 and the processing circuitry 2002. The radio front-end circuitry 2018 may be configured to condition signals communicated between the antenna 2010 and the processing circuitry 2002. The radio front-end circuitry 2018 may receive digital data that is to be sent out to other network nodes or UEs via a wireless connection. The radio front-end circuitry 2018 may convert the digital data into a radio signal having the appropriate channel and bandwidth parameters using a combination of the filters 2020 and/or the amplifiers 2022. The radio signal may then be transmitted via the antenna 2010. Similarly, when receiving data, the antenna 2010 may collect radio signals which are then converted into digital data by the radio front-end circuitry 2018. The digital data may be passed to the processing circuitry 2002. In other embodiments, the communication interface 2006 may comprise different components and/or different combinations of components.

In certain alternative embodiments, the network node 2000 does not include separate radio front-end circuitry 2018; instead, the processing circuitry 2002 includes radio front-end circuitry and is connected to the antenna 2010. Similarly, in some embodiments, all or some of the RF transceiver circuitry 2012 is part of the communication interface 2006. In still other embodiments, the communication interface 2006 includes the one or more ports or terminals 2016, the radio front-end circuitry 2018, and the RF transceiver circuitry 2012 as part of a radio unit (not shown), and the communication interface 2006 communicates with the baseband processing circuitry 2014, which is part of a digital unit (not shown).

The antenna 2010 may include one or more antennas, or antenna arrays, configured to send and/or receive wireless signals. The antenna 2010 may be coupled to the radio front-end circuitry 2018 and may be any type of antenna capable of transmitting and receiving data and/or signals wirelessly. In certain embodiments, the antenna 2010 is separate from the network node 2000 and connectable to the network node 2000 through an interface or port.

The antenna 2010, the communication interface 2006, and/or the processing circuitry 2002 may be configured to perform any receiving operations and/or certain obtaining operations described herein as being performed by the network node 2000. Any information, data, and/or signals may be received from a UE, another network node, and/or any other network equipment. Similarly, the antenna 2010, the communication interface 2006, and/or the processing circuitry 2002 may be configured to perform any transmitting operations described herein as being performed by the network node 2000. Any information, data, and/or signals may be transmitted to a UE, another network node, and/or any other network equipment.

The power source 2008 provides power to the various components of the network node 2000 in a form suitable for the respective components (e.g., at a voltage and current level needed for each respective component). The power source 2008 may further comprise, or be coupled to, power management circuitry to supply the components of the network node 2000 with power for performing the functionality described herein. For example, the network node 2000 may be connectable to an external power source (e.g., the power grid or an electricity outlet) via input circuitry or an interface such as an electrical cable, whereby the external power source supplies power to power circuitry of the power source 2008. As a further example, the power source 2008 may comprise a source of power in the form of a battery or battery pack which is connected to, or integrated in, power circuitry. The battery may provide backup power should the external power source fail.

Embodiments of the network node 2000 may include additional components beyond those shown in FIG. 20 for providing certain aspects of the network node's functionality, including any of the functionality described herein and/or any functionality necessary to support the subject matter described herein. For example, the network node 2000 may include user interface equipment to allow input of information into the network node 2000 and to allow output of information from the network node 2000. This may allow a user to perform diagnostic, maintenance, repair, and other administrative functions for the network node 2000.

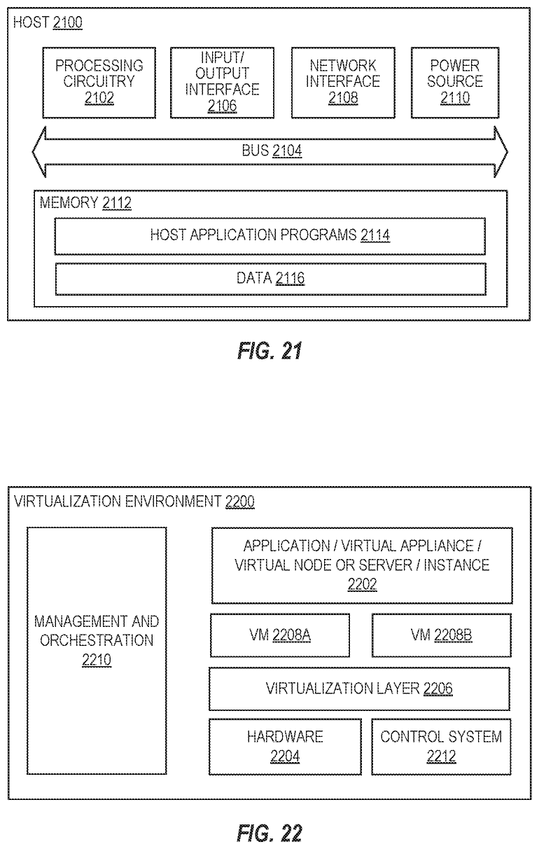

FIG. 21 is a block diagram of a host 2100, which may be an embodiment of the host 1816 of FIG. 18, in accordance with various aspects described herein. As used herein, the host 2100 may be or comprise various combinations of hardware and/or software including a standalone server, a blade server, a cloud-implemented server, a distributed server, a virtual machine, container, or processing resources in a server farm. The host 2100 may provide one or more services to one or more UEs.

The host 2100 includes processing circuitry 2102 that is operatively coupled via a bus 2104 to an input/output interface 2106, a network interface 2108, a power source 2110, and memory 2112. Other components may be included in other embodiments. Features of these components may be substantially similar to those described with respect to the devices of previous figures, such as FIGS. 19 and 20, such that the descriptions thereof are generally applicable to the corresponding components of the host 2100.

The memory 2112 may include one or more computer programs including one or more host application programs 2114 and data 2116, which may include user data, e.g. data generated by a UE for the host 2100 or data generated by the host 2100 for a UE. Embodiments of the host 2100 may utilize only a subset or all of the components shown. The host application programs 2114 may be implemented in a container-based architecture and may provide support for video codecs (e.g., Versatile Video Coding (VVC), High Efficiency Video Coding (HEVC), Advanced Video Coding (AVC), Moving Picture Experts Group (MPEG), VP9) and audio codecs (e.g., Free Lossless Audio Codec (FLAC), Advanced Audio Coding (AAC), MPEG, G.711), including transcoding for multiple different classes, types, or implementations of UEs (e.g., handsets, desktop computers, wearable display systems, and heads-up display systems). The host application programs 2114 may also provide for user authentication and licensing checks and may periodically report health, routes, and content availability to a central node, such as a device in or on the edge of a core network. Accordingly, the host 2100 may select and/or indicate a different host for Over-The-Top (OTT) services for a UE. The host application programs 2114 may support various protocols, such as the HTTP Live Streaming (HLS) protocol, Real-Time Messaging Protocol (RTMP), Real-Time Streaming Protocol (RTSP), Dynamic Adaptive Streaming over HTTP (DASH or MPEG-DASH), etc.

FIG. 22 is a block diagram illustrating a virtualization environment 2200 in which functions implemented by some embodiments may be virtualized. In the present context, virtualizing means creating virtual versions of apparatuses or devices which may include virtualizing hardware platforms, storage devices, and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more Virtual Machines (VMs) implemented in one or more virtual environments 2200 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 2202 (which may alternatively be called software instances, virtual appliances, network functions, virtual nodes, virtual network functions, etc.) are run in the virtualization environment 2200 to implement some of the features, functions, and/or benefits of some of the embodiments disclosed herein.

Hardware 2204 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 2206 (also referred to as hypervisors or VM Monitors (VMMs)), provide VMs 2208A and 2208B (one or more of which may be generally referred to as VMs 2208), and/or perform any of the functions, features, and/or benefits described in relation with some embodiments described herein. The virtualization layer 2206 may present a virtual operating platform that appears like networking hardware to the VMs 2208.

The VMs 2208 comprise virtual processing, virtual memory, virtual networking, or interface and virtual storage, and may be run by a corresponding virtualization layer 2206. Different embodiments of the instance of a virtual appliance 2202 may be implemented on one or more of the VMs 2208, and the implementations may be made in different ways. Virtualization of the hardware is in some contexts referred to as Network Function Virtualization (NFV). NFV may be used to consolidate many network equipment types onto industry standard high volume server hardware, physical switches, and physical storage, which can be located in data centers and customer premise equipment.

In the context of NFV, a VM 2208 may be a software implementation of a physical machine that runs programs as if they were executing on a physical, non-virtualized machine. Each of the VMs 2208, and that part of the hardware 2204 that executes that VM, be it hardware dedicated to that VM and/or hardware shared by that VM with others of the VMs 2208, forms separate virtual network elements. Still in the context of NFV, a virtual network function is responsible for handling specific network functions that run in one or more VMs 2208 on top of the hardware 2204 and corresponds to the application 2202.

The hardware 2204 may be implemented in a standalone network node with generic or specific components. The hardware 2204 may implement some functions via virtualization. Alternatively, the hardware 2204 may be part of a larger cluster of hardware (e.g., such as in a data center or CPE) where many hardware nodes work together and are managed via management and orchestration 2210, which, among others, oversees lifecycle management of the applications 2202. In some embodiments, the hardware 2204 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a RAN or a BS. In some embodiments, some signaling can be provided with the use of a control system 2212 which may alternatively be used for communication between hardware nodes and radio units.

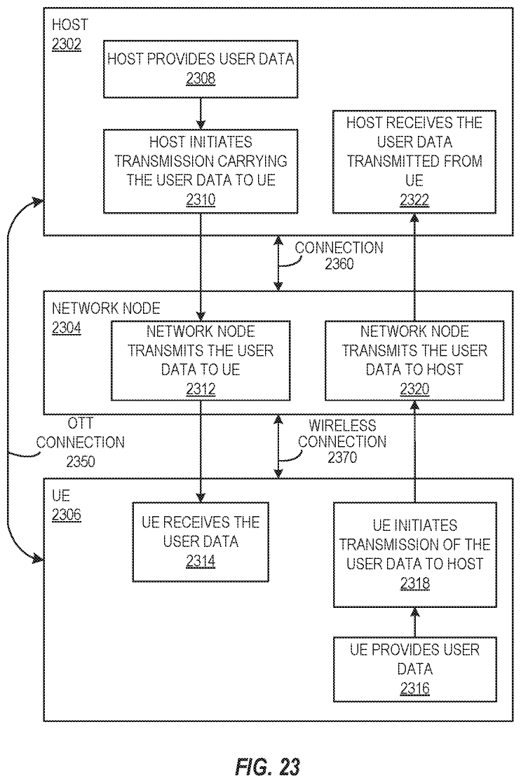

FIG. 23 shows a communication diagram of a host 2302 communicating via a network node 2304 with a UE 2306 over a partially wireless connection in accordance with some embodiments. Example implementations, in accordance with various embodiments, of the UE (such as the UE 1812A of FIG. 18 and/or the UE 1900 of FIG. 19), the network node (such as the network node 1810A of FIG. 18 and/or the network node 2000 of FIG. 20), and the host (such as the host 1816 of FIG. 18 and/or the host 2100 of FIG. 21) discussed in the preceding paragraphs will now be described with reference to FIG. 23.

Like the host 2100, embodiments of the host 2302 include hardware, such as a communication interface, processing circuitry, and memory. The host 2302 also includes software, which is stored in or is accessible by the host 2302 and executable by the processing circuitry. The software includes a host application that may be operable to provide a service to a remote user, such as the UE 2306 connecting via an OTT connection 2350 extending between the UE 2306 and the host 2302. In providing the service to the remote user, a host application may provide user data which is transmitted using the OTT connection 2350.

The network node 2304 includes hardware enabling it to communicate with the host 2302 and the UE 2306 via a connection 2360. The connection 2360 may be direct or pass through a core network (like the core network 1806 of FIG. 18) and/or one or more other intermediate networks, such as one or more public, private, or hosted networks. For example, an intermediate network may be a backbone network or the Internet.

The UE 2306 includes hardware and software, which is stored in or accessible by the UE 2306 and executable by the UE's processing circuitry. The software includes a client application, such as a web browser or operator-specific “app” that may be operable to provide a service to a human or non-human user via the UE 2306 with the support of the host 2302. In the host 2302, an executing host application may communicate with the executing client application via the OTT connection 2350 terminating at the UE 2306 and the host 2302. In providing the service to the user, the UE's client application may receive request data from the host's host application and provide user data in response to the request data. The OTT connection 2350 may transfer both the request data and the user data. The UE's client application may interact with the user to generate the user data that it provides to the host application through the OTT connection 2350.

The OTT connection 2350 may extend via the connection 2360 between the host 2302 and the network node 2304 and via a wireless connection 2370 between the network node 2304 and the UE 2306 to provide the connection between the host 2302 and the UE 2306. The connection 2360 and the wireless connection 2370, over which the OTT connection 2350 may be provided, have been drawn abstractly to illustrate the communication between the host 2302 and the UE 2306 via the network node 2304, without explicit reference to any intermediary devices and the precise routing of messages via these devices.

As an example of transmitting data via the OTT connection 2350, in step 2308, the host 2302 provides user data, which may be performed by executing a host application. In some embodiments, the user data is associated with a particular human user interacting with the UE 2306. In other embodiments, the user data is associated with a UE 2306 that shares data with the host 2302 without explicit human interaction. In step 2310, the host 2302 initiates a transmission carrying the user data towards the UE 2306. The host 2302 may initiate the transmission responsive to a request transmitted by the UE 2306. The request may be caused by human interaction with the UE 2306 or by operation of the client application executing on the UE 2306. The transmission may pass via the network node 2304 in accordance with the teachings of the embodiments described throughout this disclosure. Accordingly, in step 2312, the network node 2304 transmits to the UE 2306 the user data that was carried in the transmission that the host 2302 initiated, in accordance with the teachings of the embodiments described throughout this disclosure. In step 2314, the UE 2306 receives the user data carried in the transmission, which may be performed by a client application executed on the UE 2306 associated with the host application executed by the host 2302.

In some examples, the UE 2306 executes a client application which provides user data to the host 2302. The user data may be provided in reaction or response to the data received from the host 2302. Accordingly, in step 2316, the UE 2306 may provide user data, which may be performed by executing the client application. In providing the user data, the client application may further consider user input received from the user via an input/output interface of the UE 2306. Regardless of the specific manner in which the user data was provided, the UE 2306 initiates, in step 2318, transmission of the user data towards the host 2302 via the network node 2304. In step 2320, in accordance with the teachings of the embodiments described throughout this disclosure, the network node 2304 receives user data from the UE 2306 and initiates transmission of the received user data towards the host 2302. In step 2322, the host 2302 receives the user data carried in the transmission initiated by the UE 2306.

One or more of the various embodiments improve the performance of OTT services provided to the UE 2306 using the OTT connection 2350, in which the wireless connection 2370 forms the last segment.

In an example scenario, factory status information may be collected and analyzed by the host 2302. As another example, the host 2302 may process audio and video data which may have been retrieved from a UE for use in creating maps. As another example, the host 2302 may collect and analyze real-time data to assist in controlling vehicle congestion (e.g., controlling traffic lights). As another example, the host 2302 may store surveillance video uploaded by a UE. As another example, the host 2302 may store or control access to media content such as video, audio, VR, or AR which it can broadcast, multicast, or unicast to UEs. As other examples, the host 2302 may be used for energy pricing, remote control of non-time critical electrical load to balance power generation needs, location services, presentation services (such as compiling diagrams etc. from data collected from remote devices), or any other function of collecting, retrieving, storing, analyzing, and/or transmitting data.

In some examples, a measurement procedure may be provided for the purpose of monitoring data rate, latency, and other factors on which the one or more embodiments improve. There may further be an optional network functionality for reconfiguring the OTT connection 2350 between the host 2302 and the UE 2306 in response to variations in the measurement results. The measurement procedure and/or the network functionality for reconfiguring the OTT connection 2350 may be implemented in software and hardware of the host 2302 and/or the UE 2306. In some embodiments, sensors (not shown) may be deployed in or in association with other devices through which the OTT connection 2350 passes; the sensors may participate in the measurement procedure by supplying values of the monitored quantities exemplified above, or by supplying values of other physical quantities from which software may compute or estimate the monitored quantities. The reconfiguring of the OTT connection 2350 may include message format, retransmission settings, preferred routing, etc.; the reconfiguring need not directly alter the operation of the network node 2304. Such procedures and functionalities may be known and practiced in the art. In certain embodiments, measurements may involve proprietary UE signaling that facilitates measurements of throughput, propagation times, latency, and the like by the host 2302. The measurements may be implemented in that software causes messages to be transmitted, in particular empty or ‘dummy’ messages, using the OTT connection 2350 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions, and methods disclosed herein. Determining, calculating, obtaining, or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box or nested within multiple boxes, in practice computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hardwired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole and/or by end users and a wireless network generally.

Some of the embodiments of the present disclosure include the following embodiment

### Group A Embodiments

Embodiment 1: A method performed by a User Equipment, UE, (400) for multi-Round Trip Time, RTT, positioning using a single satellite node in a Non-Terrestrial Network, NTN, the method comprising: receiving (1308; 1500) assistance information from a location server (1302), the assistance information comprising information that indicates at least one of a plurality of time instances at which the UE (400) is to receive positioning reference signals from a single satellite node (404); performing (1309; 1502), based on the assistance information, positioning measurements on the positioning reference signals received by the UE (400) from the single satellite node (404) at the plurality of time instances; and sending (1312) the positioning measurements to the location server (1302).

Embodiment 2: The method of embodiment 1 wherein the assistance information indicates one of the plurality of time instances, and one or more remaining time instances from the plurality of time instances are derived from the one of the plurality of time instances indicated by the assistance information and a predefined or configured periodicity.

Embodiment 3: The method of embodiment 1 wherein the assistance information indicates each of the plurality of time instances.

Embodiment 4: The method of any of embodiments 1 to 3 wherein the assistance information further comprises information that indicates when the UE (400) is to start transmission of an uplink reference signal for positioning measurement(s) at the satellite node (404).

Embodiment 5: The method of any of embodiments 1 to 4 further comprising sending (1312) UE Rx-Tx time difference measurement to the location server (1302).

Embodiment 6: A method performed by a User Equipment, UE, (400) for multi-Round Trip Time, RTT, positioning using a single satellite node in a Non-Terrestrial Network, NTN, the method comprising: performing (1309-1) positioning measurements on positioning reference signals received by the UE (400) from the single satellite node (404) at a plurality of time instances; and sending (1312-1), to a location server (1302), the positioning measurements together with information that indicates at least one of the plurality of time instances.

Embodiment 7: The method of embodiment 6 wherein the at least one of the plurality of time instances indicated by the information sent to the location server is one of the plurality of time instances, and one or more remaining time instances from the plurality of time instances are derived from the one of the plurality of time instances and a predefined or configured periodicity.

Embodiment 8: The method of embodiment 6 wherein the at least one of the plurality of time instances indicated by the information sent to the location server is all of the plurality of time instances.

Embodiment 9: The method of any of embodiments 6 to 8 further comprising sending (1312-1) UE Rx-Tx time difference measurement to the location server (1302).

Embodiment 10: A method performed by a User Equipment, UE, (400) for multi-Round Trip Time, RTT, positioning using a single satellite node in a Non-Terrestrial Network, NTN, the method comprising: performing (1309-2) positioning measurements on positioning reference signals received by the UE (400) from the single satellite node (404) at a plurality of time instances; and sending (1312-2), to a location server (1302), the positioning measurements together with information that indicates positions of the satellite node (404) at the plurality of time instances.

Embodiment 11: The method of embodiment 10 further comprising sending (1312-2) UE Rx-Tx time difference measurement to the location server (1302).

Embodiment 12: The method of any of the previous embodiments, further comprising: providing user data; and forwarding the user data to a host via the transmission to the network node.

### Group B Embodiments

Embodiment 13: A method performed by a location server (1304) for multi-Round Trip Time, RTT, positioning using a single satellite node in a Non-Terrestrial Network, NTN, the method comprising: sending (1308; 1404) assistance information to a User Equipment, UE, (1300) for multi-RTT positioning using a single satellite node (1304), the assistance information comprising information that indicates at least one of a plurality of time instances at which the UE (400) is to receive positioning reference signals from the single satellite node (404); receiving (1312; 1406) positioning measurements from the UE (400) for the plurality of time instances; receiving (1316; 1408) second positioning measurements from the single satellite node (1304) that are measurements performed by the satellite node (1304) on uplink reference signals from the UE (1300) at known time instances; and calculating (1318; 1410) a position of the UE (1300) based on the positioning measurements from the UE (400), known information about the position of the satellite node (1304) at the plurality of time instances, and the second positioning measurements from the satellite node (1304).

Embodiment 14: The method of embodiment 13 wherein the assistance information indicates one of the plurality of time instances, and one or more remaining time instances from the plurality of time instances are derived from the one of the plurality of time instances indicated by the assistance information and a predefined or configured periodicity.

Embodiment 15: The method of embodiment 13 wherein the assistance information indicates each of the plurality of time instances.

Embodiment 16: The method of any of embodiments 13 to 15 wherein the assistance information further comprises information that indicates when the UE (400) is to start transmission of an uplink reference signal for positioning measurement(s) at the satellite node (404).

Embodiment 17: The method of any of embodiments 13 to 16 further comprising deriving (1402) the plurality of time instances based on a PRS processing capability of the UE (1300) and/or satellite deployment information for the satellite node (1304).

Embodiment 18: A method performed by a location server (1304) for multi-Round Trip Time, RTT, positioning using a single satellite node in a Non-Terrestrial Network, NTN, the method comprising: receiving (1312-1) positioning measurements from a UE (400) for a plurality of time instances together with information that indicates at least one of the plurality of time instances, the positioning measurements being based on downlink positioning reference signals transmitted by a single satellite node (1304) at the plurality of time instances; receiving (1316) second positioning measurements from the single satellite node (1304) that are measurements performed by the satellite node (1304) on uplink reference signals from the UE (1300) at known time instances; and calculating (1318-1) a position of the UE (1300) based on the positioning measurements from the UE (400), known information about the position of the satellite node (1304) at the plurality of time instances, and the second positioning measurements from the satellite node (1304).

Embodiment 19: The method of embodiment 18 wherein the at least one of the plurality of time instances indicated by the information received from the UE (1300) is one of the plurality of time instances, and one or more remaining time instances from the plurality of time instances are derived from the one of the plurality of time instances and a predefined or configured periodicity.

Embodiment 20: The method of embodiment 18 wherein the at least one of the plurality of time instances indicated by the information received from the UE (1300) is all of the plurality of time instances.

Embodiment 21: A method performed by a location server (1304) for multi-Round Trip Time, RTT, positioning using a single satellite node in a Non-Terrestrial Network, NTN, the method comprising: receiving (1312-2) positioning measurements from a UE (400) for a plurality of time instances together with information that indicates a position of a single satellite node (1304) at one or more of the plurality of time instances, the positioning measurements being based on downlink positioning reference signals transmitted by the single satellite node (1304) at the plurality of time instances; receiving (1316) second positioning measurements from the single satellite node (1304) that are measurements performed by the satellite node (1304) on uplink reference signals from the UE (1300) at known time instances; and calculating (1318-2) a position of the UE (1300) based on the positioning measurements from the UE (400), the position of the satellite node (1304) at the plurality of time instances, and the second positioning measurements from the satellite node (1304).

### Group C Embodiments

Embodiment 22: A user equipment comprising: processing circuitry configured to perform any of the steps of any of the Group A embodiments; and power supply circuitry configured to supply power to the processing circuitry.

Embodiment 23: A user equipment (UE) comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A embodiments; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

Embodiment 24: A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A embodiments to receive the user data from the host.

Embodiment 25: The host of the previous embodiment, wherein the cellular network further includes a network node configured to communicate with the UE to transmit the user data to the UE from the host.

Embodiment 26: The host of the previous 2 embodiments, wherein: the processing circuitry of the host is configured to execute a host application, thereby providing the user data; and the host application is configured to interact with a client application executing on the UE, the client application being associated with the host application.

Embodiment 27: A method implemented by a host operating in a communication system that further includes a network node and a user equipment (UE), the method comprising: providing user data for the UE; and initiating a transmission carrying the user data to the UE via a cellular network comprising the network node, wherein the UE performs any of the operations of any of the Group A embodiments to receive the user data from the host.

Embodiment 28: The method of the previous embodiment, further comprising: at the host, executing a host application associated with a client application executing on the UE to receive the user data from the UE.

Embodiment 29: The method of the previous embodiment, further comprising: at the host, transmitting input data to the client application executing on the UE, the input data being provided by executing the host application, wherein the user data is provided by the client application in response to the input data from the host application.

Embodiment 30: A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A embodiments to transmit the user data to the host.

Embodiment 31: The host of the previous embodiment, wherein the cellular network further includes a network node configured to communicate with the UE to transmit the user data from the UE to the host.

Embodiment 32: The host of the previous 2 embodiments, wherein: the processing circuitry of the host is configured to execute a host application, thereby providing the user data; and the host application is configured to interact with a client application executing on the UE, the client application being associated with the host application.

Embodiment 33: A method implemented by a host configured to operate in a communication system that further includes a network node and a user equipment (UE), the method comprising: at the host, receiving user data transmitted to the host via the network node by the UE, wherein the UE performs any of the steps of any of the Group A embodiments to transmit the user data to the host.

Embodiment 34: The method of the previous embodiment, further comprising: at the host, executing a host application associated with a client application executing on the UE to receive the user data from the UE.

Embodiment 35: The method of the previous embodiment, further comprising: at the host, transmitting input data to the client application executing on the UE, the input data being provided by executing the host application, wherein the user data is provided by the client application in response to the input data from the host application.

Those skilled in the art will recognize improvements and modifications to the embodiments of the present disclosure. All such improvements and modifications are considered within the scope of the concepts disclosed herein.

1. A method performed by a location server for multi-Round Trip Time (RTT) positioning using a single satellite node in a Non-Terrestrial Network (NFN) the method comprising:
sending assistance information to a User Equipment (UE) for multi-RTT positioning using the single satellite node, the assistance information comprising information that indicates at least one of a plurality of time instances at which the UE is to receive positioning reference signals from the single satellite node;
receiving, from the UE, positioning measurements for the plurality of time instances;
receiving second positioning measurements from the single satellite node that are measurements performed by the satellite node on uplink reference signals from the UE at known time instances; and
calculating a position of the UE based on the positioning measurements from the UE for the plurality of time instances, known information about the position of the satellite node at the plurality of time instances, and the second positioning measurements from the satellite node.

2. The method of claim 1, wherein the assistance information indicates one of the plurality of time instances, and one or more remaining time instances from the plurality of time instances are derived from the one of the plurality of time instances indicated by the assistance information and a predefined or configured periodicity.

3. The method of claim 1, wherein the assistance information indicates each of the plurality of time instances.

4. The method of claim 1, wherein the assistance information further comprises information that indicates when the UE is to start transmission of an uplink reference signal for positioning measurement(s) at the satellite node.

5. The method of claim 1, further comprising deriving the plurality of time instances based on a Positioning Reference Signal (PRS) processing capability of the UE and/or satellite deployment information for the satellite node.

6. The method of claim 1, wherein the known information about the position of the single satellite node is based on ephemeris data.

7-11. (canceled)

12. A location server that performs multi-Round Trip Time (RTT) positioning using a single satellite node in a Non-Terrestrial Network (NTN), the location server comprising processing circuitry that is configured to:
send assistance in formation to a User Equipment (UE) for multi-RTT positioning using the single satellite node, the assistance information comprising information that indicates at least one of a plurality of time instances at which the UE is to receive positioning reference signals from the single satellite node;
receive, from the UE, positioning measurements for the plurality of time instances;
receive second positioning measurements from the single satellite node that are measurements performed by the satellite node on uplink reference signals from the UE at known time instances; and
calculate a position of the UE based on the positioning measurements from the UE for the plurality of time instances, known information about the position of the satellite node at the plurality of time instances, and the second positioning measurements from the satellite node.

13-16. (canceled)

17. A method performed by a User Equipment (UE) for multi-Round Trip Time (RTT) positioning using a single satellite node in a Non-Terrestrial Network (NTN), the method comprising:
receiving assistance information from a location server, the assistance information comprising information that indicates at least one of a plurality of time instances at which the UE is to receive positioning reference signals from the single satellite node;
performing, based on the assistance information, positioning measurements on the positioning reference signals received by the UE from the single satellite node at the plurality of time instances; and
sending the positioning measurements to the location server.

18. The method of claim 17, wherein the assistance information indicates one of the plurality of time instances, and one or more remaining time instances from the plurality of time instances are derived from the one of the plurality of time instances indicated by the assistance information and a predefined or configured periodicity.

19. The method of claim 17, wherein the assistance information indicates each of the plurality of time instances.

20. The method of claim 17, wherein the assistance information further comprises information that indicates when the UE is to start transmission of an uplink reference signal for positioning measurement(s) at the satellite node.

21. The method of claim 17, further comprising sending UE Rx-Tx time difference measurement to the location server.

22-26. (canceled)

27. A User Equipment (UE) that performs Multi-Round Trip Time (RTT) positioning using a single satellite node in a Non-Terrestrial Network (NTN), the UE comprising processing circuitry configured to:
receive assistance information from a location server, the assistance information comprising information that indicates at least one of a plurality of time instances at which the UE is to receive positioning reference signals from the single satellite node;
perform, based on the assistance information, positioning measurements on the positioning reference signals received by the UE from the single satellite node at the plurality of time instances; and
send the positioning measurements to the location server.

28-31. (canceled)

32. The UE of claim 27, wherein the assistance information indicates one of the plurality of time instances, and one or more remaining time instances from the plurality of time instances are derived from the one of the plurality of time instances indicated by the assistance information and a predefined or configured periodicity.

33. The UE of claim 27, wherein the assistance information indicates each of the plurality of time instances.

34. The UE of claim 27, wherein the assistance information further comprises information that indicates when the UE is to start transmission of an uplink reference signal for positioning measurement(s) at the satellite node.

35. The UE of claim 27, wherein the processing circuitry is further configured to cause the UE to send UE Rx-Tx time difference measurement to the location server.

36. The location server of claim 12, wherein the assistance information indicates one of the plurality of time instances, and one or more remaining time instances from the plurality of time instances are derived from the one of the plurality of time instances indicated by the assistance information and a predefined or configured periodicity.

37. The location server of claim 12, wherein the assistance information indicates each of the plurality of time instances.

38. The location server of claim 12, wherein the assistance information further comprises information that indicates when the UE is to start transmission of an uplink reference signal for positioning measurement(s) at the satellite node.

39. The location server of claim 12, wherein the processing circuitry is further configured to cause the location server to derive the plurality of time instances based on a Positioning Reference Signal (PRS) processing capability of the UE and/or satellite deployment information for the satellite node.

40. The location server of claim 12, wherein the known information about the position of the single satellite node is based on ephemeris data.
